(19) United States
(12) Patent Application Publication
(10) Pub. No.: US 2012/0209722 A1
(43) Pub. Date: Aug. 16, 2012

(54) ELECTRONIC INTERPERSONAL ADVERTISING IN A SOCIAL NETWORK ENVIRONMENT

(76) Inventor: William J. Plut, Los Altos, CA (US)

(21) Appl. No.: 13/029,375

(22) Filed: Feb. 17, 2011

Related U.S. Application Data
(63) Continuation of application No. 13/028,428, filed on Feb. 16, 2011.

(51) Int. Cl. G06Q 30/00

(52) U.S. Cl. 705/14.67; 705/14.66

(57) ABSTRACT

Described herein are systems and methods that facilitate interpersonal electronic advertising. An intended recipient of an electronic advertisement gives consumer information relating to a potential consumer transaction to an electronic advertisement suggester. The suggester then selects or suggests an electronic ad for the intended recipient. The suggester input relates to the consumer information and helps determine the ad. The interpersonal advertising systems and methods receive the electronic ad input from the suggester. The systems and methods then send the electronic ad to the intended recipient. Activating the electronic ad, such as when the recipient purchases a product or service related to the ad, may lead to compensation for the suggester.

### CROSS-REFERENCE TO RELATED APPLICATION

This application is a continuation of and claims priority under U.S.C. §120 from co-pending U.S. patent application Ser. No. 13/028,428, filed Feb. 16, 2011 and entitled, “ELECTRONIC INTERPERSONAL ADVERTISING,” which is incorporated by reference herein for all purposes.

### FIELD OF THE INVENTION

This invention generally relates to electronic advertising, and more particularly to systems and methods that provide interpersonal electronic advertising.

### BACKGROUND

Advertising plays a central role in marketing numerous products and services. Current online advertisement providers send an advertisement to an advertisement recipient based on demographic characteristics and past contextual knowledge of the recipient, such as the online traffic content, or using information gathered from Internet searches, email content, or location detection technology.

For a number of reasons, these automated forms of advertisement based on prior online knowledge suffer from a relatively low ratio of conversion into actual purchases. First, advertisement recipients are inundated with irrelevant advertisements that collectively desensitize a viewer because the advertisements are not relevant to their current needs. Advertisements frequently show a product that has already been purchased. A person's needs change. For example, if an Internet user builds a car online at a car manufacturer's site, then the person will continue to receive ads for that car, irrespective if they actually liked the car, or whether they found a better car. Second, some advertisement providers selfishly display ads according to their highest paying advertiser, which is not necessarily fitting for a particular ad recipient.

Based on the foregoing, there is a need for systems and methods for improved electronic advertising.

### BRIEF DESCRIPTION OF THE DRAWINGS

FIG. 1 illustrates a system for sending an interpersonal electronic advertisement in accordance with one embodiment of the present invention.

FIG. 2 illustrates another system suitable for sending an interpersonal electronic advertisement in accordance with another embodiment.

FIG. 3A illustrates graphics output with an interpersonal electronic advertisement on an electronic device in accordance with a specific embodiment.

FIG. 3B illustrates graphics output with an interpersonal electronic advertisement on a mobile electronic device in accordance with another specific embodiment.

FIGS. 4A-4C illustrate advertisements in accordance with several embodiments.

FIG. 5A illustrates an advertisement suggestion interface in accordance with one embodiment.

FIG. 5B illustrates a contact selection tool in accordance with a specific embodiment.

FIG. 6 illustrates a sample suggester's social network page in accordance with one embodiment.

FIG. 7 illustrates a sample recipient's social network page in accordance with one embodiment.

FIG. 8A illustrates sample content in a social networking environment in accordance with one embodiment.

FIG. 8B illustrates an information display that is displayed when activating a portion of text included in the sample content of FIG. 8A in accordance with a specific embodiment.

FIG. 9 illustrates a process flow for sending an electronic advertisement in accordance with one embodiment.

FIG. 10 illustrates a process flow for sending an electronic advertisement in accordance with another embodiment.

FIG. 11 illustrates a process flow for sending an electronic advertisement and attributing compensation in accordance with another embodiment.

FIG. 12 illustrates a network in which systems and methods consistent with the principles of the invention may be implemented.

FIG. 13 illustrates a sample computer system suitable for implementing some embodiments described herein.

### DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Interpersonal electronic advertising methods and systems leverage information provided from an intended advertisement recipient (or ‘intended recipient’, or ‘ad recipient’, or ‘recipient’) to an electronic advertisement suggester (or ‘ad suggester’ or ‘suggester’). The ad suggester then uses this information to suggest electronic advertisements, or ads, for provision to the ad recipient. The ad recipient has a relationship with the ad suggester and often shares current and trusted consumer information with the ad suggester. The relationship can be one between friends, family members, spouses, relatives, school friends, contacts in a social networking website, among others.

The consumer information often passes from the ad recipient to the ad suggester via an interpersonal communication, such as those used with an electronic device such as a computer or mobile device (e.g., a text, email, or twitter feed) or an oral conversation. The online communication, text, or conversation may be as simple as the ad recipient telling the ad suggester that they desire to purchase something. The ad suggester now has personal and intimate and timely consumer information relating a consumer need for the ad recipient. With this consumer information, the ad suggester can suggest or select an electronic advertisement for provision to the ad recipient. For example, a man tells his cousin that he desires to purchase tickets to a concert featuring a renowned classical pianist. This is sufficient information for the cousin to select and send the man an advertisement featuring tickets to see the pianist.

In some instances, a trusted personal relationship assists the ad suggester to suggest an electronic advertisement that focuses on the ad recipient's current consumer needs, as recently divulged from the recipient to the suggester. Using an electronic device (such as a computer or mobile device) and this knowledge, the ad suggester suggests an electronic advertisement that is helpful to the ad recipient's personal needs. The ad recipient favorably receives this ad since it arrives from a trusted source with timely knowledge.

A computer or server receives electronic advertisement input (or a ‘suggestion’) from the ad suggester. The server also sends an electronic advertisement to the ad recipient.

In other embodiments, the server attributes compensation to the ad suggester for providing electronic advertisement input, which then led to the electronic advertisement being sent to the ad recipient. This pays ad suggesters to send well received ads. In large numbers, paying ad suggesters also democratizes portions of Internet advertising revenues.

In this manner, the present invention enables interpersonal electronic advertising that targets a future consumer transaction of the ad recipient, using a suggestion from an ad suggester who has knowledge of a consumer need for the ad recipient.

Embodiments described herein permit the ad suggester to use this consumer information to suggest a set of potential ads, and sometimes even specifically select a specific advertisement for the recipient by providing electronic advertisement input. The electronic advertisement is determined using at least a portion of the electronic advertisement input provided by the ad suggester. In a ski rack example, the electronic advertisement input and electronic advertisement relate to the ad recipient's desire to purchase a ski rack. In this example, an ad recipient purchased an automobile a month ago; he went online and built the desired model, test drove the car to help decide on the make and model, and bought it from a local dealer. Now, the ad recipient intends to purchase an accessory for the automobile, such as a ski rack. The ad recipient emails this ski rack consumer need information to an acquaintance, the ad suggester. The ad suggester knows that the ad recipient previously completed the automobile purchase and no longer needs automobile advertisements. By contrast, a context based advertisement provider may continue sending outdated ads for a car that has already been purchased, unbeknownst to the context based advertisement provider. Instead, the ad suggester knows that the recipient now wants to purchase a ski rack. The present invention permits the ad suggester to send an electronic advertisement to the ad recipient that corresponds to his new consumer need, a ski rack for his new car. In this manner, the ad recipient receives an electronic advertisement that is tailored to his current and individual needs which is achieved through obtaining the electronic advertisement input from the ad suggester.

One aspect of the disclosure includes a method for sending an electronic advertisement. The method comprises receiving electronic advertisement input from an electronic advertisement suggester. The electronic advertisement input relates to consumer information for an intended recipient of the electronic advertisement. The consumer information was received by the electronic advertisement suggester from the intended recipient and relates to a potential consumer transaction for the intended recipient. The method further comprises determining the electronic advertisement at least partially using the electronic advertisement input. The method further comprises sending the electronic advertisement to the intended recipient.

Another aspect of the disclosure includes a method for sending an electronic advertisement. The method comprises receiving a selection from an electronic advertisement suggester. The selection relates to consumer information for an intended recipient of the electronic advertisement. The consumer information was received by the electronic advertisement suggester from the intended recipient and relates to a potential consumer transaction for the intended recipient. The method also comprises sending the at least one electronic advertisement to the intended recipient.

Another aspect of the disclosure includes a method for sending electronic information. The method comprises receiving a suggestion for an electronic advertisement from an electronic advertisement suggester. The suggestion relates to consumer information for an intended recipient of the electronic advertisement. The method also comprises sending the electronic advertisement to the intended recipient. The method further comprises providing compensation to the electronic advertisement suggester. The compensation corresponds to the suggestion for the electronic advertisement.

A system aspect of the disclosure comprises an advertisement suggestion interface configured to receive electronic advertisement input from an electronic advertisement suggester. The electronic advertisement input relates to consumer information for an intended recipient of the electronic advertisement. The consumer information was received by the electronic advertisement suggester from the intended recipient and relates to a potential consumer transaction for the intended recipient. The system also comprises an advertisement provision module for determining the electronic advertisement at least partially using the electronic advertisement input. The system further comprises a network interface configured to send the electronic advertisement to the intended recipient.

Another aspect of the disclosure includes a computer readable medium including executable instructions for an advertising service. The computer-readable medium comprises instructions for receiving electronic advertisement input from an electronic advertisement suggester. The computer-readable medium further comprises instructions for determining the electronic advertisement at least partially using the electronic advertisement input. The computer-readable medium also comprises instructions for sending the electronic advertisement to the intended recipient.

Another aspect of the disclosure includes system for sending advertisements. The system comprises an advertisement suggestion interface configured to receive electronic advertisement input from an electronic advertisement suggester. The system further comprises an advertisement provision module for determining the electronic advertisement at least partially using the electronic advertisement input. The system also comprises at least one network interface configured to receive the electronic advertisement input and to send the electronic advertisement to the intended recipient.

A social network method for sending an electronic advertisement comprises receiving electronic advertisement input from an electronic advertisement suggester. The method further comprises determining the electronic advertisement at least partially using the electronic advertisement input. The method also comprises sending the electronic advertisement to the intended recipient in the social network, wherein the intended recipient is a member of the social network.

Another aspect of the disclosure includes a method for sending an electronic advertisement. The method comprises transmitting consumer information for an intended recipient of the electronic advertisement to an electronic advertisement suggester. The method further comprises receiving electronic advertisement input from the electronic advertisement suggester. The electronic advertisement input relates to the consumer information. The method also comprises determining the electronic advertisement at least partially using the electronic advertisement input. The method further comprises sending the electronic advertisement to the intended recipient.

Described herein are systems and methods that facilitate interpersonal advertising relating to a desired consumer transaction. The systems and methods receive electronic advertisement input from the suggester. The input relates to consumer information of the intended recipient and helps determine which advertisement(s) to send to the intended recipient. The intended recipient often directly informs the suggester of an unmet consumer need or transaction. In some cases, the input includes a selection by the suggester of a specific advertisement for provision to the intended recipient that corresponds to the unmet consumer need, e.g., an ad for a Thule ski rack that fits the recipient's new car. Also, the ad suggester may actually research the potential transaction to find a specific product (e.g., the suggester compares Thule racks with models from other ski rack vendors), and then selects a specific ad for a particular product or vendor. In other cases, the suggester just provides non-specific product input, e.g., ski rack, and the advertising engine described below determines a specific ad using non-specific input from the suggester. Thus, the electronic advertisement is at least partially determined using the electronic advertisement input and relates to the potential upcoming transaction.

Electronic interpersonal advertising systems and methods then send an electronic advertisement to the intended recipient, who may then purchase the item related to the ad. Some embodiments described herein electronically track the recipient's online activities in response to the ad in order to determine if a purchase occurs. This allows systems described herein to attribute an incentive or compensation to the suggester for initiating the transaction. In effect, the present invention enables an ad suggester to take the time to select an ad and exchange that time (and the consumer information directly or indirectly gained from recipient) for compensation, as further described below.

Techniques described herein find use with a wide array of electronics devices. For example, desktop and laptop computers are now common and may implement software that permits users to select and send and receive ads. Electronic interpersonal advertising as described herein is also suitable for use with mobile electronic devices such as personal digital assistants (PDAs), cellular telephones, smartphones, portable computer systems, thin clients, portable tablet computers, audio players, among others, because of the inherent portability of such devices.

All or portions of the subject invention may be implemented as a method, apparatus, system or article of manufacture using programming and engineering techniques to produce software, firmware, hardware or any combination thereof to control an electronic device to implement the present invention. The term “article of manufacture” as used herein is intended to encompass a computer program with executable instructions accessible from any computer readable device, carrier, or media. For example, computer readable media can include but is not limited to magnetic storage devices, optical disks, smart cards, flash memory devices among others. Of course, those skilled in the art will recognize many modifications may be made to this configuration without departing from the scope or spirit of the disclosed invention.

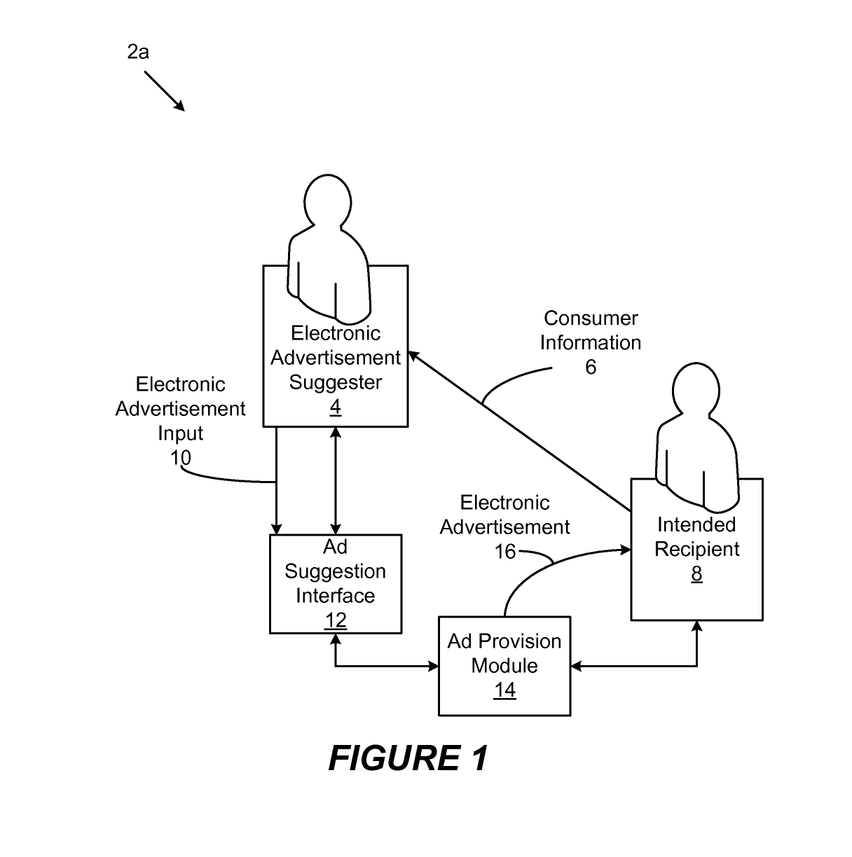

FIG. 1 illustrates a system 2a for sending an electronic advertisement in accordance with one embodiment of the present invention. System 2a includes electronic advertisement suggester 4, consumer information 6, intended recipient 8, electronic advertisement input 10, advertisement suggestion interface 12, ad provision module 14, and an electronic advertisement 16. While one view of the present invention will now be described as consumer information, hardware and software components, and people who use electronic devices, those skilled in the art will recognize that the subsequent description illustrates methods and discrete actions for providing an electronic advertisement.

Electronic advertisement suggester 4 (also referred to herein as ad suggester 4, or suggester 4) refers to any person that possesses consumer information 6 regarding an intended advertisement recipient 8. While ad suggester 4 will primarily be referred to herein as a person, it is contemplated that ad suggester 4 may also refer to a) digital identification that is maintained by ad suggester 4 or is digitally associated with ad suggester 4 (e.g., an email address for the suggester or social networking username), or b) an electronic device that is maintained, carried, or digitally associated with ad suggester 4 Suitable electronic devices include: a portable phone and/or phone number, a mobile device, a tablet, a thin client, a laptop computer, a netbook computer, a portable music player, a television, a cable display device, a desktop computer or any other electronic device configured to send and receive electronic transmissions or communications for suggester 4. For FIG. 1, suggester 4 may operate as a client as in the sample client/server systems further described below. Other electronic devices and identifying digital identification or software programs are also suitable for use with suggester 4.

As the term is used herein, intended electronic advertisement recipient 8 (also referred to herein as intended recipient 8, or intended electronic advertisement recipient 8, or intended ad recipient 8, or recipient 8) refers to any person, or device carried by that person or digital identification associated with that person, that ad suggester 4 intends to receive an electronic advertisement 16. The intended ad recipient 8 possesses consumer information 6 that relates to a potential consumer transaction. While intended ad recipient 8 will primarily be referred to herein as a person, it is also contemplated that ad recipient 8 may also refer to a) digital identification that is maintained by ad recipient 8 or is digitally associated with ad recipient 8, or b) an any electronic device owned, maintained, carried or digitally associated with by recipient person 8 and capable of displaying an electronic advertisement 16. Suitable digital identification includes an email address or social networking username that identifies recipient 8. Suitable electronic devices were described above for ad suggester 4. In some cases, intended recipient 8 only logs into the electronic device using their digital identification and then receives the suggested electronic advertisement 16. For FIG. 1, recipient 8 may operate as a client as in the sample client/server systems further described below.

Suggester 4 receives consumer information 6 from intended ad recipient 8. As the term is used herein, consumer information 6 refers to any information relating to a shopping need, consumer desire, potential purchase, or future transaction of the intended recipient. Consumer information 6 includes any information relating to a desired transaction, or any information that recipient 8 is a potential consumer of a particular product or service. Consumer information 6 may relate to any product or service that is commercially available. Examples of consumer information 6 include: a product or service, price information, location information for recipient 8 or a store offering a product or service of potential worth to recipient 8, personal information related to a purchase such as a time or place of purchase, specific or approximate or general product and/or service information, etc. In a specific example of consumer information 6, ad suggester 4 has knowledge that a friend recently purchased a house and wants to purchase a garage door opener that fits a garage door in the house. Consumer information 6 in this instance includes this knowledge of the friend's recent house acquisition, a desire to purchase a garage door opener for his garage door, and maybe specifics on the garage door or when the recipient intends to purchase the garage door opener.

Recipient 8 sends the consumer information 6 to suggester 4 via electronic mechanisms, non-electronic methods, and combinations thereof. Electronic mechanisms suitable for use herein include an electronic message such as a text message or email from intended recipient 8 to suggester 4, a twitter feed from intended recipient 8 to suggester 4, one or more portions of an online chat conversation, one or more social networking posts, among others. For each of these electronic examples, a server typically relays the consumer information 6 between the recipient 8 and suggester 4, and transmits the consumer information 6 to suggester 4. The consumer information 6 may be received directly or indirectly, as described in further detail below, and may arrive in one communication, or in pieces. For example, a husband and wife have years of information regarding consumer preferences, any and all of which may be used in part to select one or more advertisements 16 for a new consumer need 6. Thus, the consumer information 6 may also transmit from recipient 8 to suggester 4 over time, in pieces, using different media, direct and indirect means, etc. In general, consumer information 6 is not limited to any specific method(s) of conveying consumer information 6 from intended recipient 8 to suggester 4.

In a father/son jewelry example where a son has knowledge that his father has not purchased an anniversary present for the son's mother, consumer information 6 may include one or more of: information that son 4 possesses about an upcoming wedding anniversary, specific jewelry product information that mother prefers, the father's current location, an anticipated price range, that father 8 wants to do something nice for his wife 6 such as buy her jewelry, etc.

In one embodiment, suggester 4 obtains consumer information 6 directly from intended recipient 8. Suitable forms of direct communication include: an electronic message such as a text message or email from intended recipient 8 to suggester 4, a twitter feed, a face-to-face conversation or telephonic conversation, a status post, etc.

In one embodiment, the consumer information 6 of intended recipient 8 includes indication of a desired purchase, as electronically indicated by intended recipient 8 to suggester 4. In the jewelry example, father 8 sends son 4 a text message asking son 4 if he knows a jewelry store where father 8 can purchase jewelry. In another example, father 8 tells son 4 in a face-to-face conversation that he is heading to the mall near their home to purchase jewelry for a wedding anniversary. Alternatively, father 8 explicitly tells son, over email, that his anniversary is coming up and that he still has not purchased a present for mother. After learning this information first-hand from father 8, son 4 has requisite knowledge of father's consumer information 6 such that son 4 can select or suggest an electronic advertisement 16 that assists father 8 in purchasing jewelry.

In another embodiment, suggester 4 indirectly obtains consumer information 6 from intended recipient 8. Consumer information 6 indirectly obtained may come from sources other than intended recipient 8, such as an electronic source (e.g. website, social network environment, news feed, a status post, an email, a twitter post, a blog, etc) or a non-electronic source (e.g. a friend or another person, document, writing, etc). For example, son 4 indirectly learns of father's 8 approaching wedding anniversary from mother via email and that she would love for father 8 to buy her a new diamond necklace 6. By receiving this email from mother, son 4 now possesses information 6 that father 8 can use to purchase a gift for mother. In another example, son 4 obtains knowledge of the wedding anniversary from an online social network environment, such as a profile page maintained by father 8 (direct) or mother (indirect) that includes details for wedding anniversary 6. Alternatively, father 8 posts a status post in a social network environment, such as Facebook, Twitter, Orkut, etc, that his wedding anniversary is approaching and solicits gift suggestions from others that can view his status post (direct). In another specific example, son 4 indirectly obtains knowledge of wedding anniversary 6 from a computer based or paper family calendar that includes information on the wedding anniversary.

In each of the above examples, son 4 directly or indirectly obtains consumer information about an upcoming wedding anniversary putting son 4 in a position to be able to suggest an advertisement 16 for a wedding anniversary gift that father 8 can purchase for mother. In another example, suggester 4 reads a friend's social network status post that he “Hates flat tires.” This may be sufficient information for suggester 4 to provide input 10 for relevant advertisements, such as: a tow truck service, a taxi, a tire repair shop, a new tire, a rental car, and/or a new car. Examples of directly or indirectly obtaining the consumer information 6 suitable for use herein are myriad and are not to be limited to the above examples provided for sake of illustration.

In further embodiments, suggester 4 just knows of the consumer information 6 based on personal proximity between the two people. For example, son 4 has grown up living at home for many years and remembers that, every year for their anniversary, father 8 buys mother new jewelry, each year buying a piece that combines with the previous gifts. Since the son 4 knows of this tradition 6, son 4 possesses information that father 8 is highly likely to make a jewelry purchase, and when. The son 4 helps find a suitable store or sale, maybe in a city that the father 8 is currently travelling in, and provides ad input 10 accordingly.

In one embodiment, consumer information 6 includes information for a transaction that the intended recipient wishes to complete. The transaction may be at least partially computer-based or relate to a transaction that is not computer-based. An example of a computer-based transaction includes transactions made online, where the purchaser does not enter a physical store. Rather, the transaction is conducted using computers and the Internet, such as purchasing a camera from an online retailer. The purchaser never enters a physical store and the store ships the camera to the address that the purchaser provided. An example of a transaction that is not computer-based is a purchaser physically entering a camera shop and purchasing a camera from the store. It is contemplated that the intended recipient 8 may complete a transaction that is a hybrid of these types of transactions, such as purchasing a camera online and picking up the camera from a physical store for in-store pickup. In general, consumer information 6 is not limited to any particular commercial transaction or technique for executing the transaction.

In one embodiment, ad suggester 4 and intended recipient 8 have a relationship such that intended recipient feels comfortable enough to provide suggester 4 with the consumer information 6. The relationship may include trust, which then leads to an advertisement input 10 from suggester 4 based on trusted insight and knowledge by suggester 4. Sample personal relationships for suggester 4 with intended recipient 8 include: a friend 4 of intended recipient 8, a spouse 4 of recipient 8, family member 4 of recipient 8, a social networking contact 4 for ad recipient 8, a college acquaintance 4 of ad recipient 8, a business acquaintance 4 of intended recipient 8, a twitter contact 4 for recipient 8, etc. A trusting relationship eases the ability for suggester 4 to obtain the consumer information 6 from intended recipient 8. Higher quality consumer information 6 often results. Other types of personal relationships are contemplated and suitable for use herein and the present invention is not limited to any relationship between ad suggester 4 and ad recipient 8.

A relationship between suggester 4 and intended recipient 8 also improves intended recipient's 8 reception of advertisement 16. This may lead to higher rates of ad 16 activation by intended recipient 8, such as viewing the ad 16, clicking the ad 16, or purchasing a product based on ad 16. In many instances, as mentioned above, a perception of trustworthiness exists between the two people 4 and 8. When the person 8 knows that certain consumer information 6 was given to suggester 4 in a trusted communication, person 8 then expects ad 16, or welcomes the ad based on its source, and receives the ad 16 with much better reception than an ad 16 from an non-trusted source (such as a business that the person 8 has never interacted with and who paid a search service the most money for an ad spot) that is untimely or potentially unrelated to the current and changing needs of person 8. Systems and methods described herein however enable intended recipient 8 to receive an electronic advertisement 16 from a known suggester 4 and increase the likelihood that intended recipient 8 views and acts on the advertisement 16. Even if the consumer information 6 was not recently given, the recipient 8 knowing that the ad 16 came from suggester 4 and trusting suggester 4 will still lead to better reception of advertisement 16, regardless of how or when suggester 4 obtained the consumer information 6. To demonstrate the distance from conventional advertising, in the jewelry example above, conventional location based advertising may send the father an ad for a sandwich shop in a mall that the father currently walks in, even though the father just ate dinner with the son before leaving to the mall.

In addition to an increased propensity to view, click, or purchase a product based on an advertisement 16 in light of the known or trusted identity of suggester 4, a relationship with suggester 4 implies to intended recipient 8 that advertisement 16 is relevant to intended recipient's current and changing consumer needs or desires 6. Such needs and desires 6 vary continuously and an ad recipient 8 implicitly trusts another person that is aware of these ever-changing consumer needs.

Suggester 4 thus has knowledge of the intended recipient's consumer information 6 and is able to provide an electronic advertisement input 10 relating to the consumer information 6 regarding intended recipient 8. Suggester 4 is not required to have purchased a product he suggests, and not required to have used a service he suggests. Likewise, suggester 4 need not be a customer of a business, vendor or entity that sells or offers the product or service he suggests via input 10.

Electronic advertisement input 10 includes data related to any recipient 8, consumer information 6, and/or advertisement selection received by ad suggestion interface 14. In one embodiment, electronic advertisement input 10 includes information for any company, person, entity, vendor, product, or service.

In a specific example of system 2a for illustration, a son 4 knows that his father 8 needs to purchase jewelry for a wedding anniversary 6; the son 4 then selects and/or suggests one or more ads 16 to the father 8 indicative of this consumer information 6. Further, the son 4 knows where the father 8 is currently shopping, e.g., at a mall near their home, and son then selects and/or suggests one or more ads 16 to the father 8 for local jewelry stores in that mall. In a specific example, the suggested ad 16 includes a 10% or 15% discount at the advertising store. The discounting ad 16 may reflect an ongoing sale for a store in the mall. In another specific embodiment, the suggested ad 16 includes a discount or coupon for use at the advertising jewelry store specifically redeemable in this instance to entice recipient 8 to enter the store. The father 8 then may print out an ad 16 or coupon 16 or use a portable electronics device to present an electronic version of the ad 16 or coupon 16 (such as one electronically sent to the father and displayed on his phone that the participating store will honor) to redeem during a transaction at the advertising store when the father 8 arrives at the store.

The son 4 can then be compensated directly or indirectly by the advertising store where father 8 made a purchase. Some stores pay a percentage of the purchase, such as 10% of the jewelry purchase, to a business that operates system 2a in FIG. 1, a portion of which (e.g., half of the 10% on a $2000 purchase, or $100) is then paid to the son 4. The participating store pays such advertising fees since, without the son's help and timely advertising input 10, the store might not have made this particular sale to the father 8, or even worse, a competitor might have made the sale. At the least, the ad 16 alone may be enough to draw the father 8 into their store—first and before he visits the other three stores. Compensation of suggester 8 will be described in further detail below.

Suggester 4 provides electronic advertisement input 10 to help determine an electronic advertisement 16 that is intended for recipient 8. Electronic advertisement input 10 relates to a desired consumer transaction for intended recipient 8 and is at least partially derived from the consumer information 6. The input 10 typically comprises computer-based data provided by suggester 4. In one embodiment, electronic advertisement input 10 includes data for the identity of intended recipient 8 (contact input 10) and data related to consumer information 6 (advertisement input 10). In the jewelry example, son 4 provides electronic advertisement input 10 when he finds and selects a particular jewelry store and intends for father 8 to receive an electronic advertisement 16 for the jewelry store. In this example, input 10 may include specific data for a particular jewelry store that the son 4 determines using a known location for father 8. In another example, son 4 provides input 10 that his father is going to a particular mall to purchase jewelry 10, but does not specify a particular jewelry store. The mall has three different jewelry stores. Using this non-specific input, system 2a determines an advertisement 16 that corresponds to at least one jewelry store in the mall and sends the ad 16 to father 8.

In another example, input 10 includes digital media such as a song, video, playlist or combination thereof. Knowing that college friend 8 likes reggae music 6, suggester provides input 10 of a reggae playlist that features various reggae songs and/or videos. An invitation to listen to the playlist 16 is sent to college friend 8, who accepts and plays at least a portion of the playlist. Suggester 4 is then compensated for sending the playlist to college buddy.

Advertisement suggestion interface 12 allows suggester 4 to provide input 10 that permits the selection of electronic advertisement 16 for provision to intended recipient 8. Ad suggestion interface 12 receives electronic advertisement input 10 entered by suggester 4. Ad suggestion interface 12 includes any suitable computer interface or digital system that allows suggester 4 to provide input 10. As the term is used herein, suggesting an ad refers to the process of providing input 10 that at least partially determines ad 16. Selecting refers to input 10 that identifies a specific ad 16. Using ad suggestion interface 12, suggester 4 provides input 10 that may include: the results from searching for an ad related to consumer information 6, the selection of an ad 16 from a list, identification of one or more recipients 8 for ad 16, entering key words and selecting input 10 or the ad 16 based on results provided in response by ad suggestion interface 12, etc. Suitable interfaces for ad suggestion interface 12 to permit ad suggestion by person 4 include one or more of a: drop down box, search box, an ad selection graphical user interface (GUI), a menu in a social network environment, among others, that allows suggester 4 to suggest or specifically select one or more electronic advertisements 16 from a set of advertisements, among others.

In one embodiment, as suggestion interface 12 renders an ad selection GUI to provide suggester 4 with an electronic region or means to load, import, read, search, filter, etc., electronic advertisement data and can include a region to present the results thereon. These regions can include known text or graphic regions with dialogue boxes, static controls, drop-down menus, list boxes, pop-up menus, edit controls, combo boxes, radio buttons, check boxes, push buttons, text selection options, text highlight options, images, pictures, and the like. In addition, utilities to facilitate the presentation such as vertical or horizontal scroll bars for navigation and toolbar buttons to determine whether a region will be viewable can be employed. In the jewelry example, son 4 interacts with one or more of the graphical components coupled to the ad suggestion interface 12, such as entering text into a search box to search for a local jewelry store. Son 4 then selects input 10 or an advertisement 16 that corresponds to the jewelry store for provision to father 8.

In one embodiment, suggester 4 uses ad suggestion interface 12 to input a specific product or a model or brand. For example, suggester 4 uses ad suggestion interface 12 to select a particular manufacturer and model 10, e.g., selecting a Thule as a ski rack manufacturer and a specific Thule model when suggesting an electronic ski rack advertisement for provision to intended recipient 8. In other embodiments, the ad suggestion interface 12 includes a search module that enables suggester 4 to search for a particular good or service and suggest or select an advertisement 16 from the results of the search function.

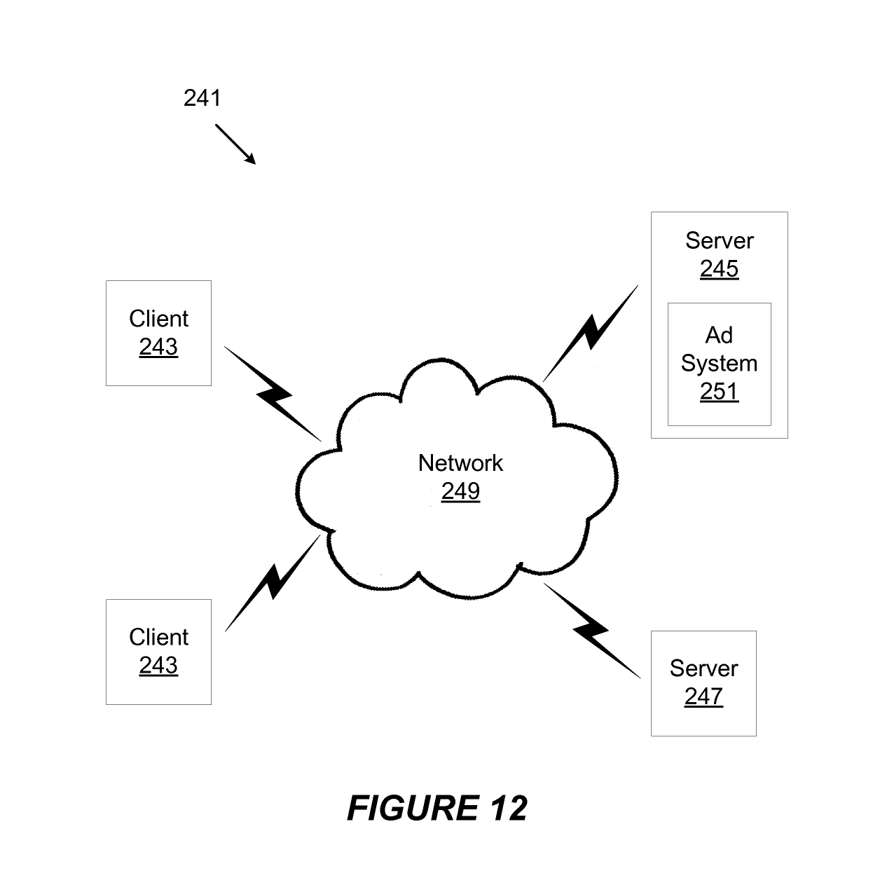

In one embodiment, ad suggestion interface 12 is implemented by a server and allows remote devices connected by Internet or other communications protocols to receive electronic advertisement input 10 from suggester 4. In this embodiment, suggester 4 usually provides the electronic advertisement input 10 for the electronic advertisement 16 using an electronic device that is usually different from the device 8 that receives the electronic advertisement input 10. In other words, because the ad suggestion interface 12 is incorporated into a device that is different than the device 4 used by the ad suggester, this leads to a client-server system for implementing system 2a, as will be described in further detail below in FIG. 12. In this embodiment, a server receives the electronic advertisement input 10 for the electronic advertisement from suggester 4. After receiving the electronic advertisement input 10 for the electronic advertisement 16 from suggester 4, the server subsequently sends the electronic advertisement 16 to recipient 8. Further description of server based systems suitable for use with the present invention are described in further detail below with respect to FIG. 12.

Advertisement provision module 14, or ad provision module 14 refers to any device, system or tool configured to send ad 16 to intended recipient 8. Ad provision module 14 is communicably connected to ad suggestion interface 12 and receives data representing or at least partially identifying ad 16 from ad suggestion interface 12. Ad provision module 14 sends data that allows intended recipient 8 to view the advertisement 16 suggested by the suggester 4 in an electronic format. In general, ad provision module 14 sends any suitable data for displaying, representing, identifying or rendering ad 16 on a device 8. In a specific embodiment, ad provision module 14 sends a jpeg image or other suitable graphics format for the ad 16 when the ad includes graphics data for display on a video device. Intended recipient 8 may view advertisement 16 on an electronic device, such as the devices described above.

In one embodiment, the electronic advertisement suggester selects a specific ad via ad suggestion interface 12, and ad provision module 14 relays this ad to the recipient 8. In another embodiment, suggester 4 only suggests a general advertisement or topic related to the ad 16 that is eventually sent to the recipient 8. In this case, the suggester does not provide input that identifies a specific ad, but provides non-specific criteria that relates to a set of advertisements that fit the non-specific criteria. The advertisement input in this case includes insufficient detail to identify an ad that will be sent. Instead, the non-specific input results in a set of advertisements that fit the non-specific criteria. This leaves ad provision module 14 to select a specific advertisement 16 that will be sent to the recipient. It should also be appreciated that an ad selected by suggester 4 may not be the same advertisement 16 that recipient 8 receives, e.g., if the ad has expired since it was created.

Electronic advertisement 16 conveys any commercial opportunity to recipient 8 or other message for a potential consumer transaction. Electronic advertisement 16 includes any format or data suitable for conveying the commercial opportunity and includes one or more of video data, audio data, text, graphics information, or any combination thereof. Electronic formats suitable for conveying and delivering ad 16 include: an email, an instant message, a text message (SMS or MMS), in situ ad in a web browser, a weblog (blog), a social network environment, a news feed, a webpage, a status post, a twitter update, graphics for display on a display device, etc. In a specific embodiment, ad 16 includes a static graphics advertisement for display on a video device determined by ad suggestion interface 12. Ad 16 may also include animations, video and other forms of attracting viewer attention and conveying a commercial opportunity. In general, the present invention is not limited to the type or content of electronic advertisement 16.

Recipient 8 may view an ad 16 in a wide variety of digital communication environments. In one embodiment, a social network environment displays the ad 16. In another embodiment, ad 16 is displayed in an online chat, instant message, mobile application, text message, or email. Ad 16 may also be displayed in the space of the recipient's internet browser dedicated to displaying ads. This may be done for any web page visited by the ad recipient. Other display schemes are contemplated and ad 16 is not limited to any specific display arrangement for ad 16.

Intended recipient 8 need not receive electronic advertisement 16 using the same medium that ad suggestion interface 12 received input 10 from ad suggester 4. In a specific embodiment, ad suggestion interface 12 is implemented in a social networking environment and receives the electronic advertisement input 10 from suggester 4 in the social networking environment and intended recipient 8 receives advertisement 16 via another medium such as a text message or email, or any suitable other electronic interface medium for receiving an ad 16. In another specific example, suggester 4 selects an advertisement 16 using ad suggestion interface 12 implemented using a software application on a mobile device, while ad 16 is displayed to recipient 8 in an email. In another specific embodiment, suggester 4 provides electronic advertisement input 10 via an ad suggestion interface 12 using a mobile phone or other mobile computing device, while recipient 8 receives a graphics ad 16 on a mobile device. In general, electronic interpersonal advertising as described herein is not limited by any particular advertisement display method or system.

In one embodiment, advertisement provision module 14 sends ad 16 to a device 8 using conventional telecommunications techniques. It is contemplated that device 8 need not be in the same location or country as ad provision module 14. For example, ad suggester 4 may be in England, provide input 10 to a server (or server network) in the United States that includes both ad suggestion interface 12 and ad provision module 14, and then the server sends ad 16 to a recipient 8 in Japan. In this case, the United States based server both receives the input 10 in the United States and sends the ad 16 from the United States. In general, given the global nature of conventional telecommunications technologies, the present invention is not limited to any geographic implementation of system 2a and is not limited by the location of ad suggester 4, recipient 8, ad suggestion interface 12, ad provision module 14, or their relative positions.

It is contemplated that some actions performed by intended recipient 8 may be performed while intended recipient 8 is not online. For example, intended recipient 8 can receive advertisement 16 on a mobile device and subsequently travel to an offline location, e.g. a store, maintained by an advertiser, or an affiliate of the advertiser, such as a merchant, retailer, wholesaler, among others. Printed ads from a computer also permit an alternative to recipient 8 from needing to bring his electronic device to a brick and mortar participating store. The recipient 8 may also use a mobile device to initiate and/or complete a transaction in an online marketplace or in a brick and mortar participating store. Such mobile commerce techniques are known to those of skill in the art. In one example, the recipient's mobile device digitally contains payment information, such as a credit card number. Participating storefronts or merchants permit the recipient to use the mobile device as a method of payment, such as using near field communication technology.

In one embodiment, system 2a tracks what recipient 8 does in response to ad 16 in order to compensate suggester 4. As mentioned above, during a transaction for a product or service, recipient 8 may present an ad 16 on a portable device where the ad 16 includes a bar code or other identifier for the ad 16 that represents advertisement redemption data that was originally supplied by the store. The store now has affirmation that their advertising investment was worthwhile. For embodiments in which suggester 4 is compensated for suggesting ad 16, either the recipient's device or the store may then send a message to the service running system 2a to inform system 2a that a transaction occurred. This results in a successful suggestion for suggester 4 and system 2a now knows to attribute compensation to the ad suggester 4.

In a specific embodiment, the store, advertiser, affiliate, or intended recipient 8 takes action to provide information to the advertisement system 2a that verifies that the desired consumer transaction occurred in response to electronic advertisement input 10. In other embodiments, system 2a implements automated notification of a transaction by recipient 8 and a store based on ad 16. So long as system 2a receives affirmation of a consumer transaction relating to ad 16, then system 2a knows that the transaction occurred and may attribute a compensation to ad suggester 4 or another compensation destination designated by suggester 4 (such as a bank account for a charity designated by suggester 4). For example, the advertiser, affiliate or intended recipient 8 accesses a network and transmits notification of a successful consumer transaction made by recipient 8 relating to the ad 16 or digital coupon 16 suggested by suggester 4.

In other embodiments, ad suggestion interface 12 is a GUI that allows suggester 4 to suggest or select an advertising entity or vendor such as a business or store that is not included in an existing set of advertisers. In such instances, suggester 4 uses the ad suggestion interface 12 to identify the new advertising entity or vendor. In a specific embodiment, suggester 4 selects, in addition to the new advertising entity or vendor, a specific product or service offered by the new advertising entity or vendor. Once suggester 4 provides the electronic advertisement input 10 using the advertisement suggestion interface 12, the system 2a sends data communication to the advertising entity or vendor informing the advertising entity or vendor that an ad 16 will be created in an attempt to bring a customer to that business. After receiving the communication, the advertising entity or vendor may decide whether to allow system 2a to provide the suggested electronic advertisement 16 to the intended recipient 8. An affirmative response from the advertising entity or vendor results in electronic advertisement provision by the ad provision module 14 to the intended recipient 8. This may also include an agreement by the advertising entity or vendor to compensate for use of the service provided by system 2a.

For example, son 4 wishes to suggest an advertisement 16 for a particular jewelry store for provision to father 8. Son 4 interacts with ad suggestion interface 12 to provide electronic advertisement input 10. Son 4 ascertains that a particular jewelry store he wishes to suggest to father 8 is not listed in an existing advertiser directory. Ad suggestion interface 12 receives a selection of the particular jewelry store from the son 4. System 2a contacts the particular jewelry store, and if the jewelry store desires father 8 to view advertisement 16 as suggested by son 4, then ad provision module 14 sends advertisement 16 to father 8. The ad 16 includes a digital coupon with an identification noted by the store, whose affirmation of usage is uploaded by a server for system 2a for subsequent compensation of son 4.

The present invention contemplates that a single person may be the suggester 4 by providing electronic advertisement input 10 and sending one or more ads 16 to his contacts 8. The same person 4 may also be an intended recipient 8 when his contacts 4 provide electronic advertisement input 10 and designate him as intended recipient 8 of at least one electronic advertisement 16.

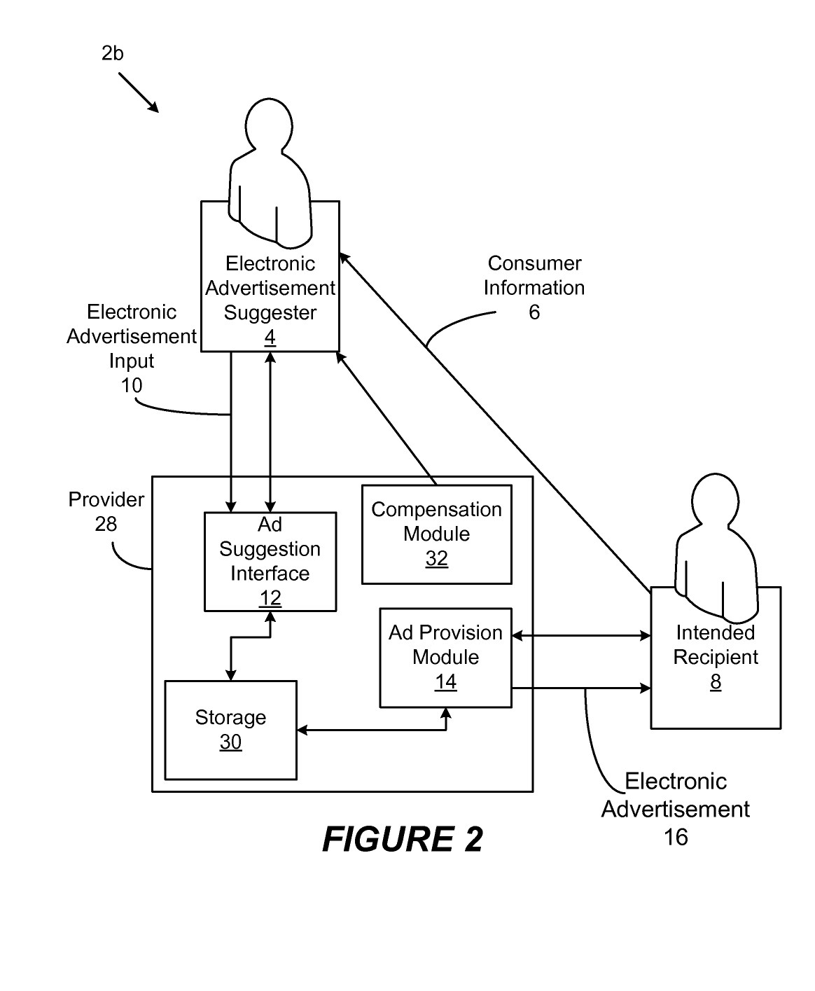

FIG. 2 illustrates a system 2b for sending an electronic advertisement 16 in accordance with another embodiment of the present invention. System 2b includes an electronic advertising provider 28 who centralizes ad suggestion interface 12, ad provision module 14 and data storage 30 and compensation module 32 for implementation of interpersonal electronic advertising system 2b.

Electronic advertising provider 28 refers to any entity that provides electronic advertisements. Provider 28 may include a social network service, online advertisement business, online search company, social networking business, among others. In another embodiment, advertising provider 28 includes any entity whose business relates to advertising and monetization of viewer space on the Internet or in a digital environment.

In one embodiment, ad suggestion interface 12 and ad provision module 14 comprise a sub-system that is maintained by provider 28. In a specific embodiment, provider 28 operates one or more servers that implement ad suggestion interface 12 and ad provision module 14. In this embodiment, ad suggestion interface 12 is accessible by suggester 4 via conventional server-based telecommunications techniques. Suggester 4 then interacts with the ad suggestion interface 12 from any location with digital connectivity to provide an electronic advertisement input 10. As described above in further detail, this server based ad selection and provision by ad provider 28 permits global implementation via one or more servers located in a single country. System 2b may also have additional server systems geographically distributed so provider 28 can service global regions more efficiently.

In one embodiment, provider 28 is a social network or social network engine or social network provider. The social network 28 may comprise a social networking website, one or more servers operating the social networking website, or any other device or application capable of providing social networking services via the network.

In one embodiment, suggester 4 and intended recipient 8 are users of the social network. Users 4 and 8 are typically members of a social networking website associated with the social network engine, for example, and thus represent two social network members. Users 4 and 8 can access the services provided by the social network via the network. Optionally, one or more of the users 4 and 8 may be able to access the social network directly. Users 4 and 8 can access the social network engine via a computing device, such as a laptop or desktop computer, a cellular telephone, a personal digital assistant (PDA), personal tablet device, thin client, a set top box, an internet TV, among others. Users 4 and 8 can view data about social network members via the social network engine, enter data about themselves and possibly others, join social network groups, suggest ads 16 to other members 8 in their social network environment, and so forth. As the term is used herein, social network environment refers to all aspects of a social network that users 4 and 8 can access, including social network contacts, friends, pages, ad locations, pictures, media, groups, etc.

Provider 28 transmits consumer information 6 for intended recipient 8 to electronic advertisement suggester 4. In one embodiment, provider 28 is a social network provider. In this case, provider 28 uses at least one social network communication tool (email, chat, status update, wall post, etc.) to transmit consumer information 6 to suggester 4. For a post, the social network provider 28 handles a recipient's request to publish consumer information 6 and electronically transmits this consumer information 6 to suggester 4. For example, a woman 8 inputs a status update to a social network, stating that she “is tired of the winter weather and needs a sunny vacation.” Social network provider 28 transmits her request and posts this status update and publishes it as her current status. Suggester 4 views her page can see this status update and consumer information 6. The social network provider 28 may also transmit and create a news feed, publishing status updates and other information on the news feed. In this instance, social network provider 28 transmits the woman's status update to the news feed for her social network contacts. Provider 28 may further transmit the woman's consumer information 6 to the suggester 4 in other electronic media, including: email, SMS, text message, twitter feed, web feed (RSS), etc. Provider 28 may also transmit the woman's status update to subscribers of her status updates.

Ad suggestion interface 12 is in digital communication with data storage 30 and ad provision module 14. In one embodiment, the ad suggestion interface 12 is configured to receive an electronic advertisement input 10 from a member of an online social network. For example, a social network environment provides both the ad suggestion interface 12 and ad provision module 14 to users of the social network. In such an example, suggester 4 interacts with ad suggestion interface 12 within the social network environment to enter input 10 used to determine electronic advertisement 16. Likewise, the online social network environment displays electronic advertisement 16 to recipient 8.

Ad suggestion interface 12 is in digital communication with data storage 30, e.g., via a network. Ad suggestion interface 12 accesses data storage 30 and provides information contained within data storage 30 to suggester 4. Ad suggestion interface 12 then receives electronic advertisement input 10 from suggester 4 who selects least one item corresponding to data in storage 30.

Data storage 30 includes any hardware and/or software for storing information related to system 2b. Data storage 30 typically contains information relating to the suggestion or provision of electronic advertisements. In a specific embodiment, data storage 30 includes information relating to: a listing of advertisements 16, an entity or vendor that is related to each advertisement, suggesters 4, intended recipients 8, advertisement suggestion interface 12, advertisement provision module 14, pointers to other websites or data locations that have products or advertisements, and electronic advertisement input 10. Data storage 30 may include a database, a table, local hard disk memory, one or more RAM devices, memory available with conventional cloud computing techniques, or any means for storing information. In a specific embodiment, data storage 30 uses a relational database such those provided by Oracle Corporation of Redwood City, Calif. In another specific embodiment, data storage 30 employs an online database service, or Database-as-a-Service, (DaaS), such as those available from Microsoft Corporation of Redmond, Wash., or Amazon.com, Inc. of Seattle, Wash.

Data storage 30 includes any data associated with system 2b such as advertisements, referrals, products, services, users, suggesters, recipients, etc. In one embodiment, data storage 30 maintains information associated with: previous ad suggestions made by suggesters 4 to intended recipients 8; data associated with successful referrals and corresponding to respective users 4 and 8; the amounts of transactions and amounts attributed as compensation to each suggester 4 in each transaction; data associated with the amount or types of compensation or incentives; data regarding a conversion ratio associated with respective users, products or services; data regarding the online and offline activity of particular users in a social network environment; account information of respective users including financial destinations for fees paid to suggesters 4; data associated with merchants or advertisement providers associated with advertisements, advertising content, promotional content, etc. Data storage 30 facilitates retrieving information associated with a user in a user account for the user, and may include tools for searching and indexing advertising data in storage. Data storage 30 also includes user accounts and all information relating to the user accounts.

In some embodiments, some or all of the system elements occupy the same physical machine, and share any resources, including processors, memory, and communication links. In other embodiments, a workflow server element is distributed across multiple scalable, fault-tolerant, redundant machines. In other further embodiments, the machines are geographically distributed across a number of sites.

Compensation module 32 attributes an incentive or compensation within interpersonal advertising system 2b. Compensation refers to any type of incentive, whether monetary, or in another form such as a discount on a present or future consumer transaction, coupon, merchandise, award, products, services, electronic tokens, virtual currency, rebate, among others.

Compensation module 32 attributes compensation to a compensation destination designated by suggester 4. Module 32 can attribute compensation directly to ad suggester 4, or to another compensation destination specified by suggester 4, such as a charity that suggester 4 is trying to raise funds for. For example, an ad suggester may provide a personal checking account number to the interpersonal ad service 2b via ad suggestion interface 12; compensation module 32 subsequently deposits funds in the specified checking account. Other examples of compensation destinations for receiving compensation include: a bank account, PayPal account, Spare Change account, among others. Bank accounts may include personal accounts, business accounts, those for charitable organizations, etc. Digital credits and tokens are also suitable for use.

Compensation as contemplated herein is not limited by who receives the funds as a result of any action by an ad suggester 4 or recipient 8. In other words, the financial destination need not belong to the suggester. For example, a grandparent may add the funds to the bank account for a grandchild. A suggester that supports a charity may designate the charity, or a specific bank account for a charity if known, as a financial destination for one or more ad revenues. Multiple people may also specify the same charity, thereby cumulatively generating significant funds for the charity only using actions by its supporters. In one embodiment, compensation module 32 maintains a record of suggester's electronic advertisement input 10 and the electronic advertisement 16 that corresponds to the input 10 which was sent to intended recipient 8. In this instance, the computing system need not provide the compensation to ad suggester 4; it only attributes the compensation to ad suggester 4 and keeps a record of the attributed compensation.

Compensation module 32 receives a notification that recipient 8 activated electronic advertisement 16. Module 32 may place or embed a tracking identifier and/or tracking program for an advertisement, which refers to a unique identifier or software used to track the status of the ad, such as a tracking number, an alphanumeric code, a hexadecimal string, a cookie, etc. Whenever recipient 8 activates the ad, that activation is tracked by module 32. If a product or service is purchased, then recipient 8 pays the advertiser, vendor or seller, or an intermediary for either, and the advertiser, vendor or seller compensates electronic advertising provider 28 for that activation. In one embodiment, compensation module 32 uses cookies to track ad and purchase status or other recipient 8 activity in response to an ad 16.

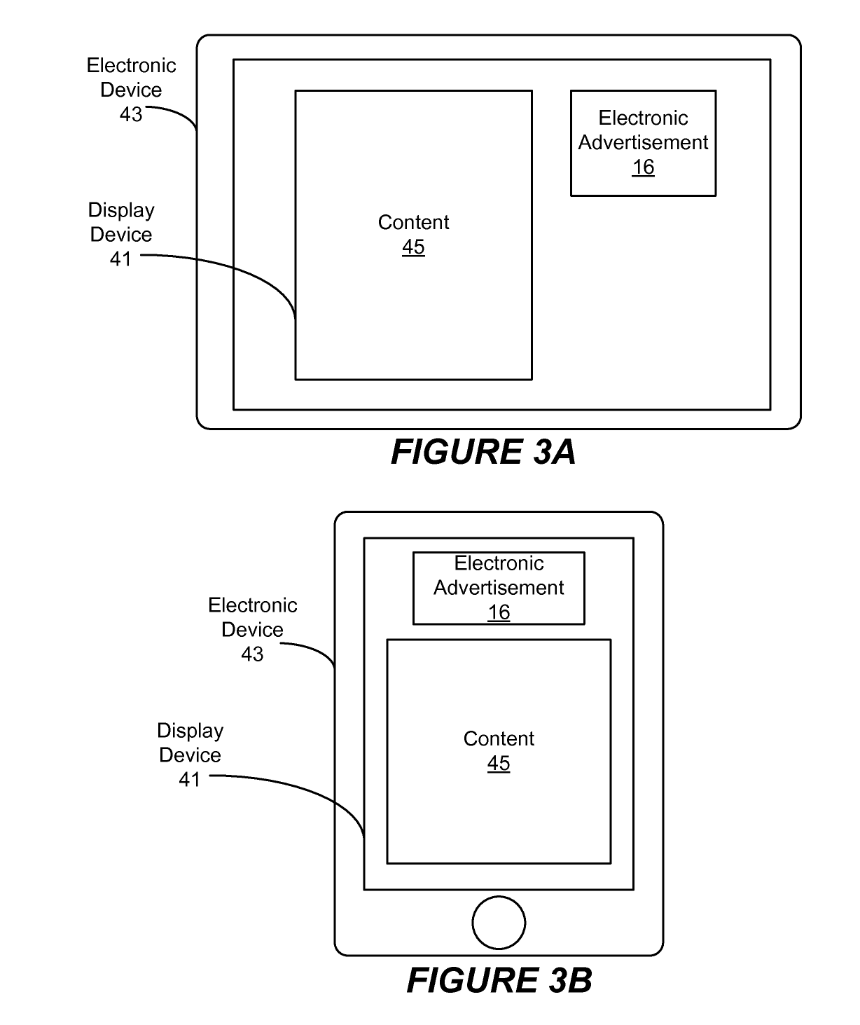

Referring now to FIG. 3A, recipient 8 receives at least one electronic advertisement 16 displayed on a display device 41 included with an electronics device 43 employed by recipient 8. Display device 41 provides graphics and/or video output that includes the at least one electronic advertisement 16 for viewing by recipient 8. Display device 41 includes any conventional apparatus for providing static or dynamic video content. Suitable display devices 41 and electronic devices 43 include: a computer screen 41, a television screen 41, a browser on such a display device 41, a display device 41 on a laptop 43, a display 41 on a handheld device 43, a display 41 on a cellular telephone 43, a display 41 on a tablet computer 43, a display 41 on a thin client 43, a display 41 on an audio player 43, etc. Display 41 displays a plurality of information, including content 45 and at least one electronic advertisement 16.

Content 45 refers to any subject matter that the intended recipient 8 views on display 41. Content commonly includes one or more of: a web page, an email, a blog, a text message, an instant message, or any other form of electronic subject matter or communication. For example, while intended recipient 8 views a webpage within a browser on display device 41, at least one electronic advertisement 16 appears on the display device 41, e.g. within the webpage or beside it in the display area for display device 41.

In another specific embodiment, the ad 16 is the subject matter and content of an email or text message. In this case, the sender sends an email directly to the recipient as a mechanism for delivering an ad 16; the recipient may then click on a link embedded in the email to then forward to a website to make a purchase that is tracked by the interpersonal advertising service and associated with the efforts of the ad sender.

FIG. 3B illustrates graphics and/or video output configured for visual output on an electronic device 47 of smaller sizes, such as those on a portable device or handheld device 47 that includes a portable display 41, in accordance with a specific embodiment of the present invention. As shown in FIG. 3B, the portable or handheld display 41 displays content 45 and at least one electronic advertisement 16.

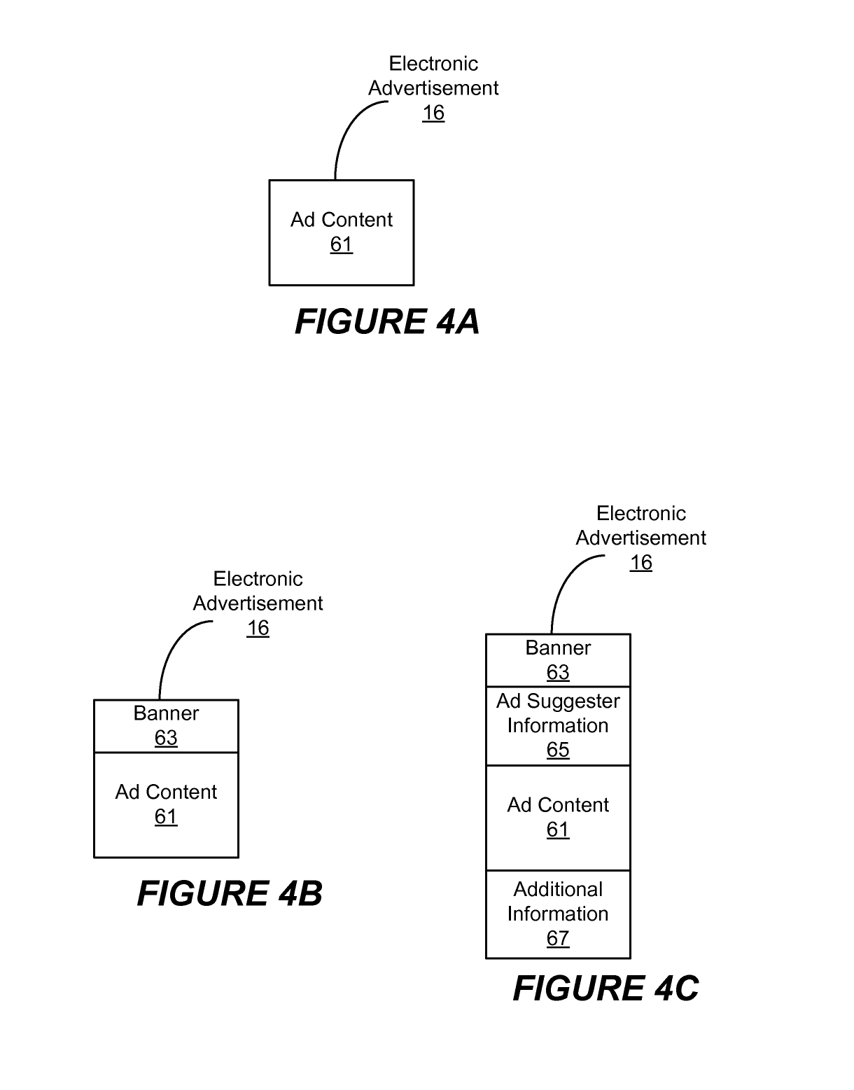

Turning now to FIG. 4A, the electronic advertisement 16 is an offer to engage in a transaction between an intended recipient 8 of the electronic advertisement 16 and a vendor. Electronic advertisement 16 corresponds to the input 10 from suggester 4. Electronic advertisement 16 comprises advertisement content 61, or ad subject matter 61.

Electronic advertisement content 61 includes at least one of a subject and a vendor, and displays graphics and/or video information relating to a particular company, vendor, person, product or service, public service announcement, news issue, corporate matter, or political person or topic, etc. Commercial advertisements 16 include ad content 61 that markets a particular product or service and can request, suggest or desire that a particular action be performed by intended recipient 8, such as a transaction or purchase. The Ad content 61 may also convey a purchase offer, deal, or discount or savings offered by clicking though the Ad to make a purchase. For example, using the ad 16 may lead to 15% off of a purchase. Content 61 may also include information of the recipient of any suggestion funds, such as a charity. Advertisement content 61 can include product images, box shots, videos, descriptive information, and/or hyperlinks to an online location, such as a Uniform Resource Locator (URL) that when activated, directs the recipient 8 to a website operated by entity vendor that provided the advertisement. The URL may also direct the recipient 8 to a website operated by a merchant that is offering the product or service in the advertisement 16 The URL may further direct recipient 8 to a website that permits the recipient 8 to initiate a transaction related to the advertisement 16, such as making a purchase. For example, one specific jewelry store advertisement includes an image of a particular piece of jewelry 61, such as a diamond necklace, and promotional content 61 such as a message stating that “all diamond necklaces are 20% off when you show this advertisement.” Alternative subject matter 61 for ad 16 is also contemplated.

FIG. 4B illustrates another embodiment of an electronic advertisement 16 that includes ad content 61 and a banner 63 in accordance with a specific embodiment of the present invention. Banner 63 includes information relating to a company or service that provides electronic advertisement 16 to intended recipient 8. For example, banner 63 may identify electronic advertisement provider 28 from FIG. 2, or a service mark or trade name for provider 28. In another specific embodiment, advertisement 16 includes promotional content, an offer, a request to contact a friend (e.g., “email a friend”, “tell a friend”, “refer a friend”), and any content that requests, suggests, or desires that intended recipient 8 take a desired action corresponding to advertisement 16.

In another embodiment, banner 63 helps intended recipient 8 to become a suggester 4. The banner 63 in this embodiment may then include one or more of: instructions on how to become a suggester 4, a link to become a suggester 4, a promotion for intended recipient 8 to become a suggester 4 and receive a special compensation, etc. The recipient 8 then becomes a suggester 4 to provide electronic advertisement input 10 to a second intended recipient 8. In this manner, banner 63 promotes proliferation of electronic advertisements 16 and interpersonal advertising techniques described herein.

FIG. 4C illustrates another specific embodiment, where electronic advertisement 16 includes banner 63, ad content 61, ad suggester information 65, and additional information 67.

Ad suggester information 65 refers to information related to the identity of suggester 4 or the selection of ad 16. Identifying suggester 4 helps recipient 8 know that ad 16 came from a known and potentially trusted person with personal knowledge of the ad recipient's needs 6, as opposed to some online business without such proximity and trust. Information related to the selection of ad 16 may include a date that suggester 4 provided the electronic advertisement input 10, how input 10 was entered, whether it was the first or second ad for a particular product or service, etc. Suggester information 65 may include one or more of: the name of suggester, an email address maintained by suggester, a unique identifier that identifies suggester, an account username, a profile identification (ID), an image, a picture, a drawing, an avatar, a conversion rate, etc. For example, a jewelry advertisement 16 suggested by son 4 to father 8 includes suggester information 65 that notifies father 8 that his own son 4 suggested the jewelry store advertisement 16. In another example, ad suggestion information includes suggester's conversion rate. The conversation rate refers to the percentage of interpersonal electronic advertisements 16 that this suggester has sent that have been converted into purchases. This permits the recipient to readily determine if this particular ad 16 comes from a trusted source 4 that sends few but relevant ads (who likely has a high percentage) as opposed to a suggester 4 who sends many ads albeit with a low percentage conversion rate. The conversion rate may be solely for this particular recipient 8, or for all recipients 8 of this suggester 4, or among recipients 8 of social network contacts for a suggester 4 such as, “39% of your friends made a purchase using suggester's advertisements.”

Additional information 67 permits provider 28 with space to provide other information related to ad 16. In one embodiment, additional information 67 includes an indication of the subject of the electronic advertisement 16 and provides intended recipient 8 a general impression of the subject matter of electronic advertisement 16. For example, generic additional information 67 may recite a generic term for ad content 61, such as “diamond necklaces,” or “ski racks.” In another example, additional information 67 is more specific, such as a manufacturer or model number or both of a particular ski rack. Additional information 67 may also identify a charity that multiple ads 16 will receive at least a portion of the proceeds of the transaction when acted upon by their respective recipients 8.

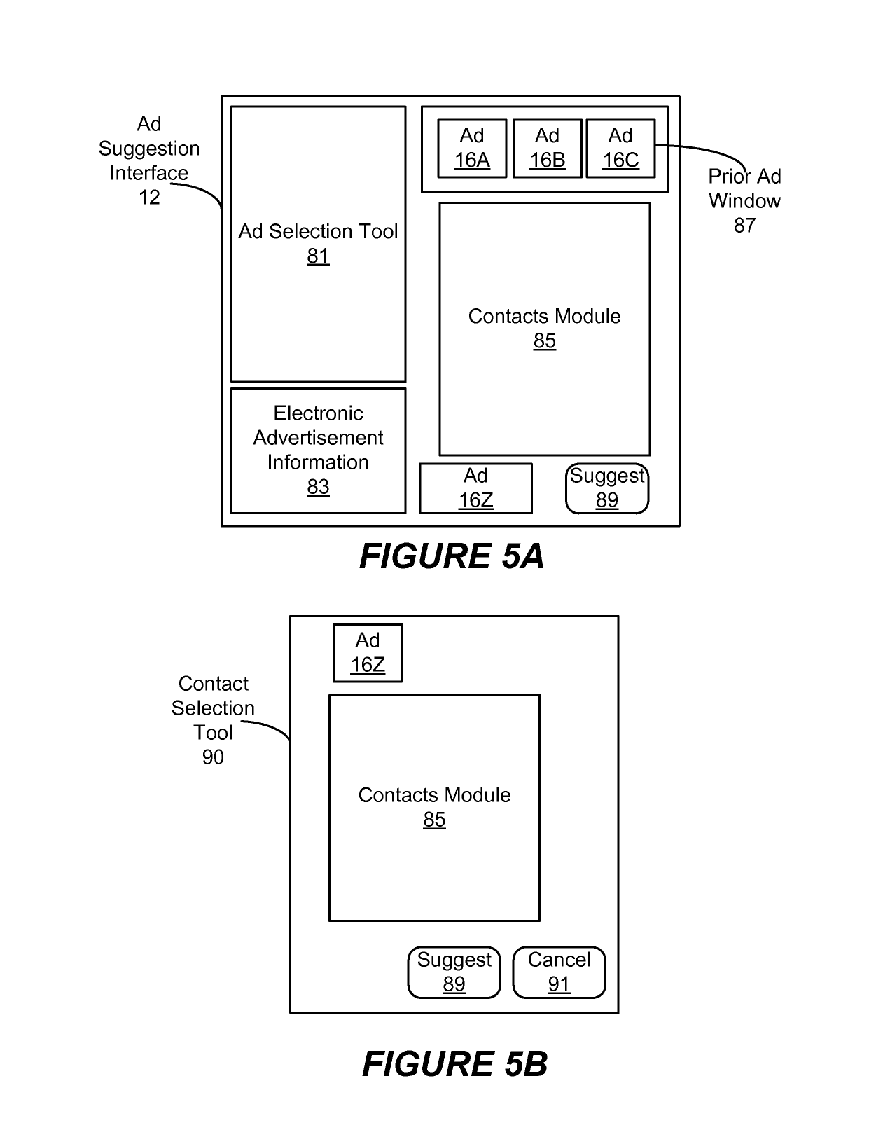

FIGS. 5A and 5B illustrate an ad suggestion interface 12 in accordance with specific embodiments of the present invention. In one embodiment, ad suggestion interface 12 is configured to generate an ad suggestion graphical user interface on a display device 41 for reception of ad input 10 that relates to an electronics advertisement 16 by suggester 4.

Ad suggestion interface 12 includes various graphical user interface selection tools and data entry tools that assist suggester 4 in suggesting or selecting an ad 16 for recipient 8 and for providing input 10 into the ad system 2a or 2b. Ad suggestion interface 12 is suitable for display on any electronic device 41 and/or computer interface, such as on an LCD display and within a social network environment, a browser, or another suitably configured electronic interface.

FIG. 5A illustrates a sample ad suggestion interface 12 configured to receive electronic advertisement input 10 from ad suggester 4 in accordance with a specific embodiment. Ad suggestion interface 12 includes multiple graphical user interface tools that allow ad suggester 4 to enter input 10 relating to consumer information 6 for intended recipient 8. Ad suggestion interface 12 contains ad selection tool 81, electronic advertisement information 83, contacts module 85, and prior ad window 87.

Ad selection tool 81 includes one or more graphical user interface tools that are configured to allow suggester 4 to select one or more ads 16 for recipient 8 or to input consumer information 10 that permits the selection of one or more ads 16 for recipient 8. In one embodiment, ad selection tool 81 returns a specific ad 16 or set of ads 16 based on input of consumer information 6. Tools suitable for this include: a search tool based on text input 10 that includes subject matter used in finding an ad, a prior ad list (e.g., a thumbnail of each ad) 87, an ad searching tool that stores ads (e.g., a thumbnail of each ad) logically arranged in a tree or folder organization that suggester 4 can browse to locate a specific ad 16, etc. Ad selection tool 81 contemplates a wide variety of other tools that permit a person 4 to provide electronic advertising input or select an ad 16. This includes picture-based ad search queries and tools, search boxes that produce product listings with a small ad picture for each product in response to a search query, prior ad search tools such as a prior ad window described in further detail below, drop-down boxes for ad selected, or any other suitable graphics tool for providing input 10 to help select an ad 16.

Ad selection tool 81 receives input 10 from suggester 4 when suggester provides at least one of: a selection of an ad, a selection an item from a drop-down list, a query in a search box, a selection of an item from a search result, a selection of a click-box, a selection of a hyperlink, a selection from a graphical user interface, a selection from a pop-up window, a selection from a menu, a selection from a browser, a selection from a browser plug-in, a selection from a social network environment tool, a selection from a mobile application, and/or a selection of an electronic advertisement. Other methods or providing an interface to receive input 10 within the spirit of the present invention are myriad and the present invention is not limited to any specific method or configuration that permits a suggester 4 to find a specific ad or provide input 10.

In another embodiment, ad selection tool 81 receives consumer information input 10 from suggester 4 for transmission of the input 10 to ad suggestion interface 12, e.g., at a remote server. In this case, suggester 4 need not select or suggest a specific product or service or price; ad suggestion interface 12 may include one or more tools that permit suggester 4 to provide input 10 or suggest an advertisement 16 for a company, person, entity, vendor, product, or service. The remote server then selects a specific ad in response to the non-specific input 10 given.

Advertisement information 83 displays commercial information for a specific ad 16 that is useful for selecting the ad 16. This includes commercial information relating to one or more of: a business, person, entity, vendor, product, location, website, article, music, video, or service, or commercial information defined by an ad search criteria, such as geography, type or name or description of product or service, price, compensation for an activation, etc. Suggester 4 may use this ad information 83 in light of consumer information 6 to provide a suggestion of at least one company, person, entity, vendor, product, or service within input 10, or to begin a selection process or search for an ad. In a specific embodiment, advertisement information 83 shows details of an ad 16 in tool 81 that a user scrolls over.

In another embodiment, advertisement information 83 displays compensation information for the suggester 4. For example, advertisement information 83 may state how much suggester 4 will be compensated if the recipient makes a purchase according to the current ad 16. Advertisement information 83 may also include information relating to any company, person, vendor or entity that has provided suggester 4 with an incentive or compensation. In another embodiment, the advertisement information 83 displays multiple ads 16 in a ranked format, where the ranked format is at least partially based on the incentive or compensation attributed to suggester 4.

Contacts module 85 includes one or more graphical user interface tools that are configured to allow suggester 4 to designate the identity of an ad recipient 8 for an ad 16. In a specific embodiment, contacts module 85 allows suggester 4 to select a name or email or social networking username or other digital identifier for recipient 8 from an existing list of contacts. Another suitable contact selection graphical user interface tool includes a text box for suggester 4 to type an email address, phone number, username, etc. of ad recipient 8.

In one embodiment, ad suggestion tool 12 receives input 10 from ad suggester 4, who used ad selection tool 81 to select electronic advertisement information 10 and, and used a contacts module 85 to designate an intended recipient 8 or group of intended recipients 8. The input order for the ad subject matter and contact may vary: suggester 4 may select the contact 8 or group of contacts 8 before inputting the electronic advertisement information 10 and navigating the one or more ad selection tools 81. Using the jewelry example, son 4 may select father 8 from the contacts module 85, then find a jewelry retailer using ad selection tool 81. Alternatively, suggester 4 may select an ad 16 using one or more ad selection tools 81 prior to selecting the contact 8 or group of contacts 8. In addition, the process may be iterative and switch between electronic advertisement information 83, one or more ad selection tools 81, and contacts module 85. Ad selection is not limited by any order of determining components of an ad within interface 12.

In one embodiment, ad suggestion interface 12 provides graphical user interface tools that allow suggester 4 to sort previous selected and/or viewed items 81 and 83 or advertisements 16. This enables suggester 4 to quickly select these previously items 81 and 83 or advertisements 16 to use as input 10 for ad 16 for another provision to an intended recipient 8. In one embodiment, ad suggestion interface 12 creates a favorites list of advertisements 16, which is a list of frequently or previously provided inputs 10. To illustrate using the jewelry store example, knowing of his parents' upcoming anniversary, son 4 viewed jewelry store information 83 using ad suggestion interface 12 when he was looking for an advertisement 16 for a jewelry store to suggest to father 8. Regardless of whether son 4 actually suggested an advertisement for the jewelry store 16, ad suggestion interface 12 stores son's viewing history and allows son to quickly access the same jewelry store information 83 that he previously viewed. Son 4 may use the viewing history to quickly suggest an advertisement to father 8. Additionally, son 4 may use the viewing history to suggest an advertisement for the same jewelry store 16 to his mother 8 so she can purchase an anniversary gift, such as a new watch for father. It is also contemplated that ad suggestion interface 12 may receive data to manipulate the items displayed in the viewing history, such as an data to always display, or “pin,” a particular electronic advertisement information 83 or advertisement 16. Other data include: data to never display (i.e. unwanted Barbie doll advertisements), data to display based on a priority (i.e. always show performance car parts in a list), among others. Other data within the spirit of ad suggestion are myriad and ad suggestion interface 12 is not limited to any specific viewing history configuration.

In one embodiment, the ad suggestion interface 12 provides graphical user interface tools that allow suggester 4 to sort previously selected and/or favorite contacts 8. This enables suggester 4 to quickly select these contacts 8. In one embodiment, ad suggestion interface 12 receives data input to prioritize a favorite contact or contacts and then populates a favorite contacts list. Another embodiment allows data input relating to frequently selected contacts 8. In the father/son example, son 4 suggested an advertisement 16 for provision to father 8. When son 4 accesses the ad suggestion interface 12 to suggest another ad 16, father 8 appears on a previously selected recipient list. In light of the father/son relationship, son 4 likely plans to suggest multiple advertisements 16 for provision to father 8 over a period of time and son 4 may also proactively add father 8 to a favorites list. Other methods to prioritize display of a contact or contacts are suitable for use and the ad suggestion interface 12 is not limited to any specific contact prioritization tool or technique.

In one embodiment, the group of contacts 8 includes a predetermined set of individual contacts. For example, suggester 4 selects a group of contacts 8 from a group created or maintained by the suggester, such as “College Friends,” “Work Friends,” or “Dinner Group Friends.” In another embodiment, contacts module 85 includes one or more graphical user interface tools that are configured to allow suggester 4 to select a group of contacts 8 defined by a particular characteristic of the contacts, such as a group of contacts 8 that share a common geography, workplace, school, fan group, etc. For example, contacts module 85 includes one or more group tools that suggester 4 uses to select a group of contacts in the “Silicon Valley, Calif.” Network (geography), “Google” (workplace), “Santa Clara University” (school) or “Skiing in Mongolia” (fan group). In another specific embodiment, contacts module 85 includes a graphical user interface tool that permits suggester 4 to create an ad-hoc group of contacts by selecting a plurality of contacts from the contacts module 85 of the ad suggestion interface 12.

In another embodiment, ad suggestion interface 12 includes a prior ad window 87 that displays at least one of: input 10 previously selected using ad selection tool 81, electronic advertisement information 83 and an advertisement 16 that suggester 4 has previously selected and/or viewed. In one embodiment, prior ad window 87 includes at least one previously selected advertisement 16, such as advertisements 16 previously provided to a contact 8 or contacts 8 in a social network environment. In a specific embodiment, prior ad window 87 also includes details on the recipient 8 or recipients 8 of each advertisement 16A-16C.

Each advertisement 16A, 16B and 16C in prior ad window 87 displays at least a portion a prior ad 16, or sample ads 16 selected using ad selection tool 81, or one or more pieces of electronic advertisement information 83 for each ad 16 that permits suggester 4 to identify or recognize the ads 16. For example, an ad 16A in prior ad window 87 may depict: “Thule ski rack”, a product type (ski rack), manufacturer (Thule), discount (15% off retail price), location (local sporting goods store), etc.

In another specific embodiment, each prior advertisement 16A, 16B and 16C displays a thumbnail, or a low resolution mimic of a full electronic advertisement. Similarly, advertisements 16A, 16B and 16C in prior ad window 87 include sample ads 16 elected using ad selection tool 81, electronic advertisement information 83 or low resolution ads 16 that suggester 4 previously selected for provision to the same or another contact 8.

In one embodiment, ad suggestion interface 12 first receives input 10 from suggester 4 to select ad 16Z. Current ad 16Z shows which ad the user currently has elected to suggest. For example, selecting or clicking on one of the ads 16A, 16B or 16C turns ad 16Z into the chosen ad. Clicking ‘Suggest’ 89 constitutes input 10 to interface 12 for current ad 16Z. A thumbnail for ad 16Z in contact selection tool 90 (FIG. 5B) serves as a reminder to suggester 4 of the input 10 selecting using ad selection tool 81 or electronic advertisement information 83 already determined while selecting one or more recipients 4.

Using the jewelry example, son 4 suggests an advertisement 16 for a jewelry store, which is displayed as ad 16A in prior ad window 87, by clicking on the thumbnail for ad 16A. Current ad 16Z then equals the jewelry store ad 16A in prior ad window 87. Son 4 also previously suggested an ad 16B for a new family computer, and an ad 16C for a new sports car, all to his father 8. Although FIG. 5A illustrates three prior advertisements, prior ad window 87 may include another suitable number of prior advertisements.

In one embodiment, suggest tool 89 permits the user to execute delivery of the ad input 10 and send the input 10 to a server. As shown, suggester 4 executes input 10 by clicking the electronic “Suggest” button 89 for current ad 16Z.

Ad suggestion interface 12 permits a suggester 4 to select and send advertisements 16A, 16B and 16C to any combination of contacts 8 from contacts module 85.

Turning now to FIG. 5B, another specific embodiment for ad suggestion interface 12 includes a contact selection tool 90 as a separate window. Contact selection tool 90 includes one or more graphical user interface tools that permit a suggester 4 to choose one or more contacts 8 from contacts module 85. In one embodiment, ad suggestion interface 12 first receives input 10 from suggester 4 to select input 10 corresponding to ad 16Z. For example, if son 4 selected a ski rack, then current ad 16Z displays ski rack input 10 selected using ad selection tool 81, ski rack information 83, or a specific ad 16 for a ski rack that was selected. Following this selection, ad suggestion interface 12 presents suggester 4 with a new window displaying contact selection tool 90, which includes contacts module 85. Using contacts module 85, ad suggester 4 inputs a selection of at least one contact 8.

Suggest tool 89 permits the user to trigger delivery of the ad selection and send the input 10 to the ad suggestion interface 12 of FIG. 1. Suggester 4 executes input 10 by selecting and clicking an electronic “suggest” button 89. Alternatively, contact selection tool 90 may receive cancel input from suggester 4 that selected cancel button 91, and system 2a or 2b directs suggester 4 back to ad suggestion interface 12.

Electronic advertisement input 10 includes selection of at least one contact 8 from contacts module 85 and either a) the selection of a specific ad 16, or b) less specific electronic advertisement input 10 using ad selection tool 81 that ad interface 12 of FIG. 1 uses to determine a particular ad 16. For example, the suggester may simply input “ski rack” into a search box, click suggest button 89, and interface 12 then selects an ad 16. Once suggester 4 provides electronic advertisement input 10 and the ad 16 has been determined, ad provision module 14 of FIG. 1 sends the ad 16 and converts a contact from contacts module 85 into an intended recipient 8.

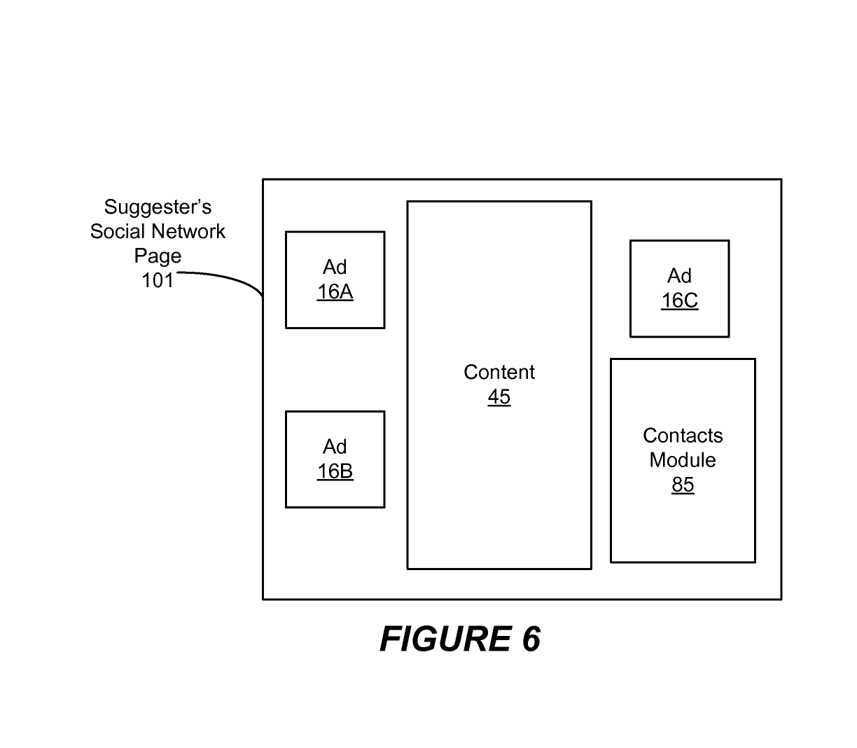

FIG. 6 illustrates a social network environment 101 in a social network where the suggester 4 contributes at least a portion of the content displayed in the social network environment in accordance with a specific embodiment of the present invention. Social network environment 101 includes social network content 45 and at least one advertisement 16. In one embodiment, social network environment 101 is a social network profile page 101 for suggester 4. In this case, social network content 45 for profile page 101 includes content personal to suggester 4.

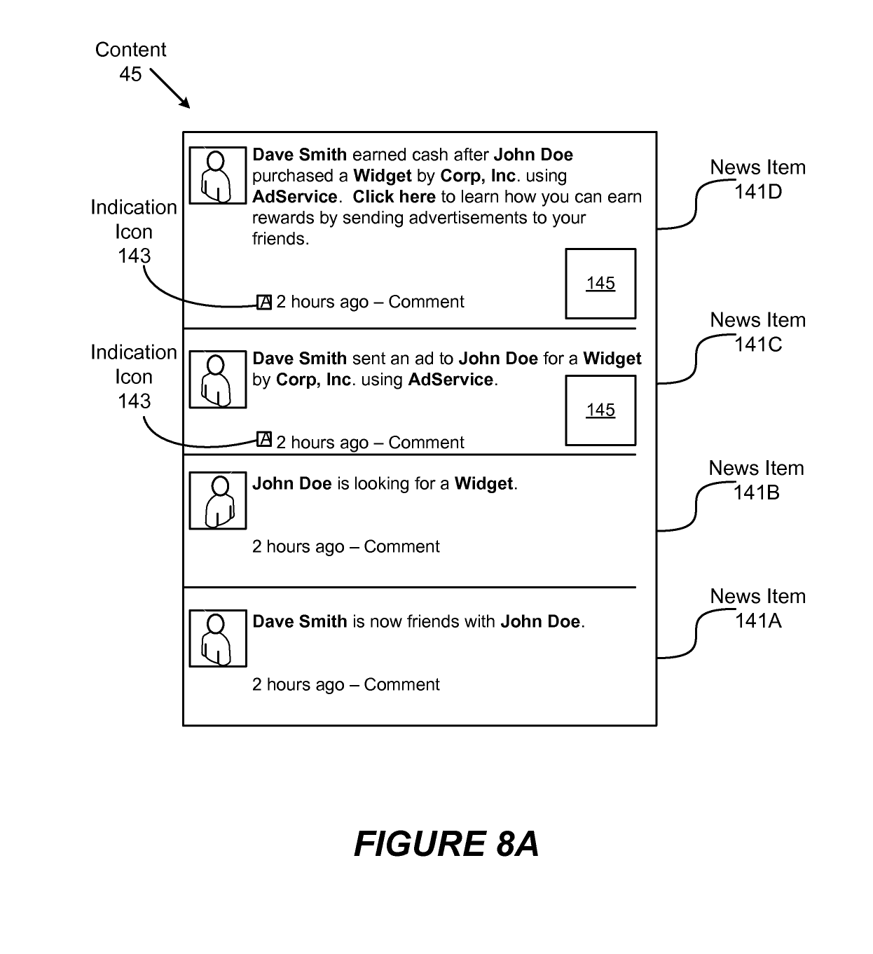

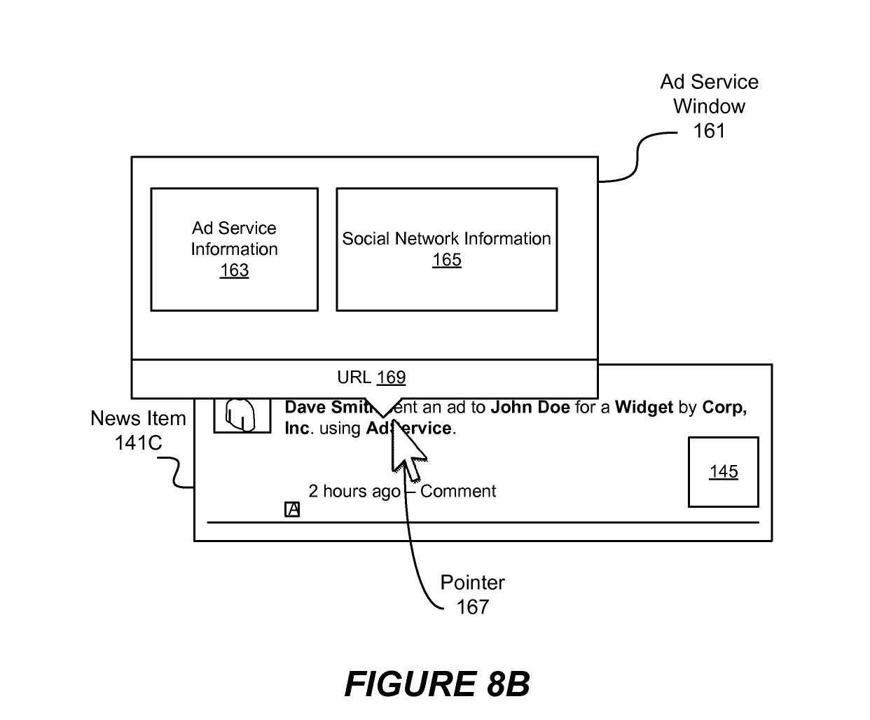

Social network content 45 relates to the social network environment for suggester 4 and is described below in further detail with respect to FIG. 8A.

Social network environment 101 permits suggester 4 to place ads selected by him on social network environment 101 such that viewers to his environment 101 see the suggester's ads, activate as many of them as possible, thereby compensating the suggester 4 for his ad selection time, consumer information 6, and social networking activities.

In a specific embodiment, the social networking environment 101 displays one or more customized advertisements 16 that are tailored to each viewer. In this embodiment, one or more ads 16 custom to a first intended recipient 12 are displayed on a page in a social network environment 101 when the first intended recipient 12 views suggester's social network profile page 101. In the jewelry example, when the father 8 visits his son's profile page 101, son's 4 suggested advertisements include a jewelry store ad 16A, a new family computer ad 16B, and a sports car ad 16C. In this manner, father 8 views each of these advertisements when he views son's social network profile page 101 and the ads 16 are custom presented to father 8 since the social network service is aware of both father's identity and the son's when the father views environment 101 for the son, permitting ads to be tailored accordingly. Social networking page 101 then displays different ads 16 when a different intended recipient 8 views page 101. For example, when mother 8 views son's social network profile page 101, the page 101 displays advertisements 16 suggested by son 4 for mother 8 such as an advertisement for books mother wants in ad 16A, a new family computer displayed in ad 16B, and a spa getaway package in ad 16C. Social network page 101 is aware of the viewer based on their known identity and logging in within the social networking environment.

In another embodiment, suggester 4 selects ad 16B for provision to a group of contacts 8, as described above in further detail. Social network page 101 then displays ad 16B when any member in the group of contacts views the social networking webpage 101. Using the example above, the son 4 may select a group consisting of his parents 8 to send both father 8 and mother 8 an advertisement for a new family computer 16B. In another example, friend 4 provides electronic advertisement input 10 corresponding to discount ski passes for a particular resort 16 to a group of friends 8 planning a ski vacation to the particular resort. When someone in this group of friends 8 views friend's social network profile page 101, the social network displays an advertisement 16 for the particular ski resort. In a further example, friend 4 and group 8 are planning a ski trip to Salt Lake City, Utah. Friend 4 provides electronic advertisement input, 10 that corresponds to the same group of ski trip friends 8, for discount ski passes for all resorts in the Salt Lake City area, the geographical region corresponding to the ski vacation destination. In this manner, the social network displays an advertisement 16 from at least one ski resort in the Salt Lake City area when any one of the group of friends 8 views friend's social network profile page 101.

Ads 16A, 16B and 16C provide targeted electronic advertisement 16 for provision to a single intended recipient 8 or designated group of contacts 8. In this manner, electronic advertisements 16 displayed on the social networking webpage 101 may change and adapt to a particular viewer 8 of the suggester's webpage 101, providing customized ads 16 directed to an intended recipient 8.

Social network environment 101 is not limited by the number of ads 16 displayed on webpage 101, the placement of the ads, or the content of the ads. While the social networking webpage 101 displays three advertisements, it is contemplated that webpage 101 may display any number of ads 16. In one embodiment, social network webpage 101 shows between one and ten ads 16. In a specific embodiment, social network webpage 101 displays between three and five ads 16.

The present description also contemplates a situation where suggester 4 provides more electronic advertisement input 10 and ads 16 than available places for electronic advertisements ads on page 101. To handle an ad 16 excess, in one embodiment, ad provision module 14 uses a ranking system to determine a display hierarchy of electronic advertisements 16. The ranking system uses an algorithm that ranks or prioritizes the ads 16 based on one or more criteria. Criteria suitable for use in the display hierarchy includes: a relationship status between suggester 4 and intended recipient 8 (e.g., the father may rate his son and wife as high priorities for receiving ads, and old college friends lower), a conversion rate of ads 16 provided from suggester 4 to intended recipient 8 (e.g., ads from a suggester with a higher conversion rate receive higher priority over ads with a lower conversion rate), and/or a date (e.g., older ads 16 are reduced in the hierarchy while newer ads rank higher). Other criteria are contemplated and suitable for use. The relationship status includes personal relationships between suggester 4 and a friend 8, a family member 8, a spouse 8, a relative 8, a fraternity brother 8, among others.

In a specific embodiment, the conversion rate refers to a global conversion rate of all suggested advertisements 16 for ads sent to all recipients by suggester 4 and not to any particular recipient. In another specific embodiment, the conversion rate is based on the conversion rate between suggester 4 and intended recipient 8 in a one person to one person manner. In other embodiments, the conversion rate is calculated based on a conversion rate among a defined group of contacts 8. A combination of these global, personal, and group-based conversion rates is also suitable for use. In other embodiments, the conversion rate includes calendar information such as when suggester 4 suggested the ad 16, when intended recipient 8 activated the ad 16, etc. The conversion rate may also be limited by a subgroup and may be used to demonstrate suggester's prowess in suggesting advertisements. In this instance, the conversion rate subgroup may relate to a defined relationship, an area of expertise, a domain of knowledge, among others. Ad 16 may also include and show the conversion rate. For example, Frequent Traveler 4 who is well versed in travel suggests numerous travel-related ads 16 to his contacts 8, with 90+% of these travel ads being activated by contacts 8. Frequent Traveler's 4 conversion rate for the subgroup of travel, 90+%, is relevant to others 8 that receive advertisement 16 from Frequent Traveler 4 because it shows the recipients that Frequent Traveler is an accomplished and knowledgeable travel advertisement suggester 4 amongst his social networking contacts.

In another embodiment to handle an ad excess, social networking profile page 101 is configured to control ad display priority within the page 101. In this embodiment, the social network receives ad display configuration data from a maintainer of profile page 101, which may override or work in conjunction with any automated controls and prioritizes ads based on the maintainer's personal preference. For example, a person may prioritize ads based on one or more of: potential compensation for the suggester (or another recipient of the compensation such as a charity), the perceived value of the ad to the recipient, the date of the ad, combinations thereof, etc.

In another specific embodiment, social network page 101 also includes contacts module 85, as described above in further detail. Contacts module 85 includes a listing of contacts, and may designate a listing of contacts that are available for online chat. In one embodiment, the online chat transpires within the contacts module 85. In this embodiment, ads 16 are only displayed according to the listing of contacts that are available for online chat. In another specific embodiment, chat users 4 are permitted to select other chat contacts 8 to initiate the advertisement suggestion process of FIGS. 1 and 2.

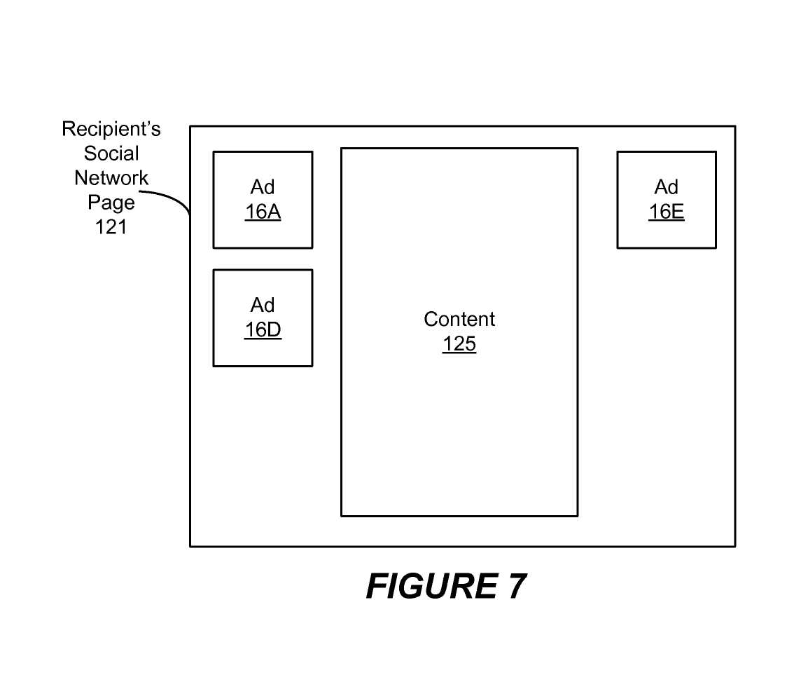

FIG. 7 illustrates a social network environment 121, such as a profile page maintained by intended recipient 8 in accordance with another specific embodiment. Recipient's profile page 121 displays social network content 125 and at least one electronic advertisement 16. Social network content 125 for profile page 121 includes content personal to recipient 8.

Recipient's social network profile page 121 displays a plurality of advertisements 16. When viewed by intended recipient 8, recipient's social network profile page 121 displays advertisements 16A, 16D and 16E which were suggested by intended recipient's friends 4, family 4, or other social networking contacts 4. The plurality of advertisements 16A, 16D and 16E may derive from a single suggester 4 or from multiple suggesters 4. Electronic advertisement 16A, for example, is the electronic advertisement that suggester 4 selected for provision to intended recipient 8 discussed above and was displayed when recipient views the suggester's social network profile page 101. In the father/son jewelry example discussed above, ad 16A includes commercial information relating to an ad for a jewelry store, which was suggested by son 4 to father 8. The social network displays ad 16A to father 8 when father 8 views son's profile page 101 and when father 8 views his own profile page 121. In one embodiment, electronic advertisement 16D was suggested for provision to intended recipient 8 by a second suggester 8, or represents a second advertisement from the suggester of ad 16A. By way of example, ad 16D is an advertisement for new truck tires from father's 8 friend 4, who recently purchased the tires for his own truck, which is a similar model. Ad 16D permits the father's friend 4 to make money from ad 16D and leverage the research performed or knowledge that the friend 4 has in selecting tires for his own truck. In another embodiment, electronic advertisement 16E is an electronic advertisement from a third suggester 4, as discussed above for ad 16D. By way of example, ad 16E is an advertisement for a hotel for a Hawaiian vacation as provided by mother 4 based on a recent family planning email between the mother and father, where mother did the research on Hawaiian hotels but father will do the actual purchase. It should be appreciated that electronic advertisements 16A, 16D and 16E may all either derive from the same suggester 4 or from different suggesters 4 and that any number of advertisements are suitable for display on page 121.

FIG. 8A illustrates a sample video image of one or more news items 141 displayed as content 45 (or 125) in a social network in accordance with another specific embodiment. Content 45 is displayed on a page such as 101 or 121 in a social network environment or on a social network home page, group subdivision, fan page, application, game, among others. Other content display schemes are contemplated and the present invention is not limited to any specific display scheme. FIG. 8A depicts four news items 141 regarding activity of a user “Dave Smith.” It should be appreciated by those skilled in the art, however, that a social network environment displays any number of news items, and that activity within the social networking environment often determines the number of news items 141 that are displayed.

The news items 141 include various activities of the user “Dave Smith” or any of his contacts. For example, a bottom news item 141A indicates that Dave Smith is now friends with another user with the username “John Doe.”

A second news item 141B indicates that John Doe is looking for a Widget. News item 141B depicts one example of electronically providing consumer information 6 from intended recipient 8 to suggester 4.

A third news item 141C indicates that Dave Smith sent an ad to John Doe for a Widget, such as a plane ticket, using an ad provision service. The electronic ad service and software application includes resources for selecting and sending electronic advertisement as described herein. In place of the widget or specific plane ticket recommendation, the ad 16 may include a suggestion to purchase any commercial product, service, device, or other item that is exchangeable for compensation. In one embodiment, the news item 141C for an ad 16 also includes at least one of a name, icon, logo, or other identifier of a company 145 that offers the product or service. News item 141C may also link via an embedded Uniform Resource Locator, or URL, to a website that sells the product or service. The URL can be embedded in the image such that it does not show the actual URL. The URL may also represent double embedded links, such as a destination website, i.e. www.genericwebsite.com, and a URL shortener, i.e. gnrc.web. The electronic ad service may then track such online movements to verify that a purchase has been made in order to compensate the ad suggester 4. In another embodiment, the news item 141B also displays a conversion rate 65, as further described above in FIG. 4C.

A fourth news item 141D indicates that Dave Smith received an incentive or compensation because John Doe acted in response to the electronic advertisement input and purchased a Widget. In one embodiment, news item 141D is displayed on both the social network environment 101 for suggester 4 and social network environment 121 for recipient 8. In another embodiment, news item 141D is displayed on a news feed in a social networking environment in a manner that it is viewable by at least one person other than suggester 4 and intended recipient 8.

News items 141C and 141D also include an indication icon 143 that informs the viewers of the news items 141C and 141D that the news item relates to the electronic ad service and software application. Indication icon 143 includes an image, logo, trademark, trade dress, service mark or other identifier that indicates a particular company, vendor or entity that provides the electronic advertisement provision service.

FIG. 8B illustrates an ad service window 161, in accordance with another specific embodiment, that provides, to a viewer, information relating to an electronic ad service that provides interpersonal electronic advertisements as described herein. In this case, ad service window 161 includes electronic advertisement service information 163, and social network information 165.

Service details 163 describe, identify, or highlight aspects of the electronic advertisement provision service or a company that provides such services. Information in service details 163 may include: a company logo, a company name, a pictorial company identifier, a company trademark, an image, a picture, text, or any other item that identifies or provides service details on the electronic advertisement provision service. In a specific embodiment, service details 163 include a hyperlink that directs to a web-based page maintained by the electronic advertisement service.

In another embodiment, ad service window 161 includes other details regarding the electronic advertisement provider, such as a company location, or a coupon, special, etc.

Social network information 165 includes information related to a social network in which users have engaged in the electronic advertising provision service, either by suggesting advertisements to other users or by receiving advertisements from other users or combinations thereof. For example, ad service window 161 displays a message informing the viewer that “74 of your friends are making money using an electronic ad service.”

In one embodiment, a viewer opens or activates ad service window 161 by clicking a hyperlink. The hyperlink is embedded in at least a portion of text contained in the news item 141D. For example, the electronic ad service name contains such a hyperlink. In another embodiment, the ad service window 161 is displayed when the viewing user moves a display pointer 167, such as a cursor, over text in news item 141D. In other embodiments, ad service window 161 is displayed when the viewing user clicks on, drags or moves a cursor or other similar means over a particular hyperlink, and the ad service window 161 is displayed in an expanded and more detailed format, such as the format shown in FIG. 8B. The ad service window 161 is displayed on any portion of an electronic display device, and may also include a banner or graphics bubble that is opened. For example, the ad service window 161 is displayed adjacent to the hyperlink.

Ad service window 161 may also include information for new users and how to join or associate with the advertisement service. This may include a hyperlink 169 that directs the viewer to a website operated by the ad service provider. Each of the above listed services may be provided by a single entity or by multiple entities acting together to provide the interpersonal ad provision services.

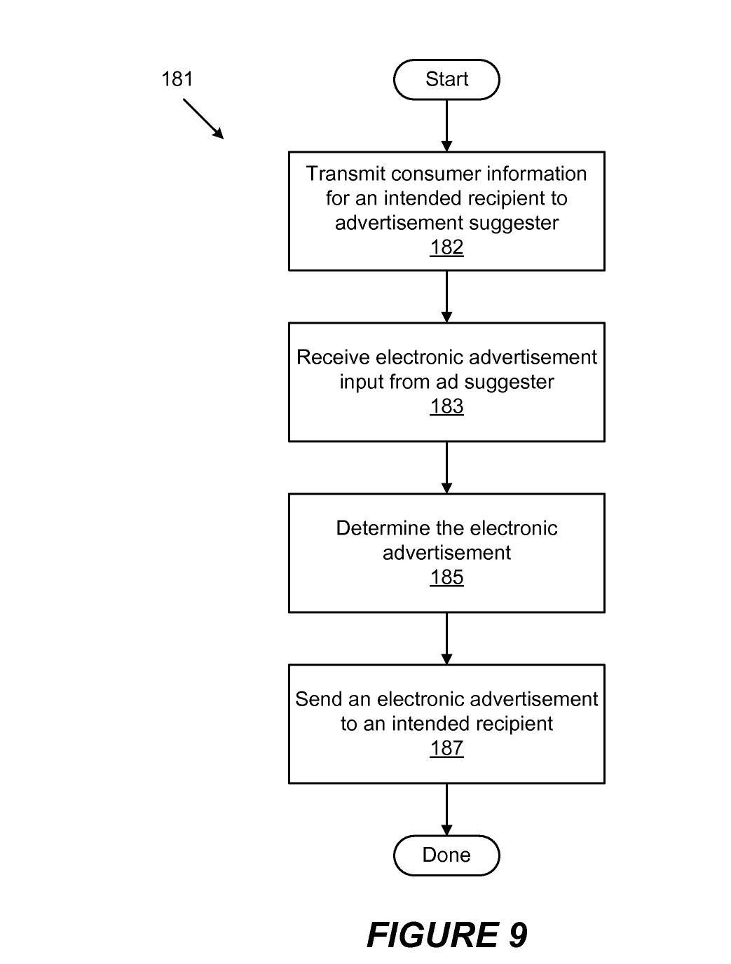

FIG. 9 illustrates a process flow 181 for sending an electronic advertisement in accordance with one embodiment of the present invention. While the present invention will now be described as a method and separable actions for electronic advertising, those skilled in the art will recognize that the subsequent description may also illustrate hardware and/or software systems and items capable of performing the method and actions. In one embodiment, process flow 181 uses a computer or server-based system configured to perform as follows.

Process flow 181 begins by transmitting consumer information for the intended recipient to the electronic advertisement suggester (182). This transmission may include sending of an email, a social network update, cellular telephone message, internet message, text message, etc that includes the consumer information. In the case of a social network, the social network provider uses at least one social network communication tool (email, chat, status update, wall post, etc) to publish the consumer information for receipt by the suggester. The social network handles the recipient's request to publish consumer information and electronically transmits this consumer information to the suggester. The social network also may create a news feed, transmitting or publishing consumer information on the news feed as status updates. Process flow 181 may transmit consumer information to suggester in numerous other forms of electronic media, including: email, SMS, text message, twitter feed, web feed (RSS), etc.

Process flow 181 continues by receiving electronic advertisement input from an electronic advertisement suggester (183). The electronic advertisement suggester is a person or device used by a person that sends advertising input for selecting or suggesting an ad to an electronic advertising system. The device may be a portable computing system owned by the suggester, or a device in which the suggester temporarily logs into or operates. Process flow 181 may also receive at least a portion of the input from a scanning device, such as a code scanner configured to scan a tag on or in an object, such as a barcode, an RFID tag, magnetic strip, data matrix, among others. The ad input may specify one recipient or multiple recipients, and/or one ad or a plurality of ads. One suitable server based system for receiving electronic advertisement input was further described above in FIG. 1.

In one embodiment, the electronic advertisement suggester selects a specific ad. In this case, the suggester is referred to as an electronic advertisement selector, or selector. Ad selection input in this case includes sufficient specificity to identify the ad based on one or more actions from the selector as determined by one or more received inputs. For example, the selector may select an ad that they sent previously, where the input includes an identifier (e.g., a specific number that corresponds to the ad) for the ad. Alternatively, the selector performs multiple steps in the input, such as a) searching for an ad, and b) selecting a specific ad that was provided in the search results; the input includes an identifier for the ad selected from the search. As another illustrative example, the advertisement input designates a named ski resort in the Salt Lake City area, such as ‘Alta,’ and constitutes a named and specific ad selection for an ad belonging to the Alta ski resort. For a specific selection by the selector, process flow 181 receives advertisement input that identifies a particular advertisement.

In another embodiment, the electronic advertisement suggester only suggests a general advertisement or topic related to the ad that is eventually determined and sent to the recipient. In this case, the suggester does not provide input that identifies a specific ad, but provides non-specific criteria in the input to indicate a set of advertisements that fit the non-specific criteria. The non-specific criteria correspond(s) to the consumer information given by the intended recipient. The advertisement input in this case includes insufficient detail to specifically identify the ad that will be sent. Instead, the non-specific advertisement input results in a set of advertisements that fit the non-specific criteria. This leaves process 181 to determine a specific advertisement that will be sent to the recipient (in 185, below). The level of detail in the non-specific ad input does not limit process flow 181; process flow 181 receives any level of advertisement input detail, so long as an advertising computer or system implementing the ad service can determine a set of ads that suitably fit the non-specific criteria.

For example, the non-specific input may only include “ski resort” and “Salt Lake City” entered into a search box, of which there are multiple possible ads for ski resorts in the Salt Lake City area. In another example, suggester wants to send an advertisement for any “ski resort” in “Salt Lake” that has at least has “two quad lifts.” This again produces multiple ads that fit the non-specific input. In another example, the ad suggester still does not have a preference on a particular resort, but he wants a resort closest to the Salt Lake City International Airport based on knowledge of the recipient's travel itinerary, which was emailed from the recipient to the suggester, and enters “ski resort” and “Salt Lake City” and “near airport” into a search box.

Next, in 185, process flow 181 determines the electronic advertisement to be sent to the recipient. In one embodiment, process flow 181 receives definite input that identifies a particular advertisement, such as input that identifies an ad for specific product, such as a daily lift ticket to Alta Ski Resort. In this instance, process flow 181 determines the electronic advertisement (including the graphics and other details) solely using the electronic advertisement input.

In another embodiment, the process flow 181 at least partially uses the electronic advertisement input from the suggester along with logic to determine which ad fitting the non-specific input criteria will be sent. This is useful when process flow 181 receives a suggestion and input that logically corresponds to a set of advertisements. A search from the suggester (e.g., “ski resort Salt Lake City”) that produces multiple suitable ad candidates is one such indefinite input, in which process flow 181 responds with multiple suitable ad candidates in response to the input. Process flow 181 then uses logic to select which candidate ad becomes the ad sent to the recipient.

The ad selection logic may include any suitable logic to select an ad for sending to a recipient from a list of candidate ads that result from non-specific input from the suggester. Examples of suitable logic include one or more of: past ad activity for the suggester and/or recipient, cost of the product or service, a commission size for the ad, a conversion rate of the product or service in the past (for the recipient or multiple recipients), a preferred advertiser that paid to have preferential treatment in such instances, etc. In this manner, process flow 181 determines an advertisement from the corresponding set of advertisements that fit the non-specific input.

For example, in the non-specific ski resort example described above where non-specific input only included “ski resort” and “Salt Lake City” in a search box, process flow 181 determines a specific resort from the set of ski resorts in the Salt Lake City area that makes the suggester the most money when the ad is redeemed by the recipient. This is not necessarily the most expensive product or service; a $50 lift ticket that pays the suggester 10% upon purchase by the recipient pays more than a $70 lift ticket that pays the suggester 5% upon purchase. In the example where the suggester input for an ad for a ski resort closest to the Salt Lake City International Airport, process flow determines an advertisement based on a set of ads for resorts that are close. Process flow 181 may respond with an ad for the closest ski resort, or another one that is relatively close but fits other logic, such as an ad for a second closest resort only a mile farther but that pays the suggester twice as much.

In another example of non-specific input for the father/son jewelry scenario, process flow 181 receives input (183) that the father needs an ad for a local jewelry store—now—based on the son's knowledge that the father is currently shopping for jewelry for mother's anniversary. This may come in a text message from father's phone to the son, for example. In a specific embodiment, process flow 181 uses the logic of the father's location to determine a jewelry store that is proximate to the father's known location. Process flow 181 may receive the location-based information from the son, from the father, or may use location-based technology, such as a Global Positioning System (GPS) in the father's phone or other portable device to locate the father, and select an advertisement for a jewelry store that is close to his current location. Thus, process flow 181 may use any suitable logic to determine an ad based on an indefinite input from the suggester provided that it makes the determination using, at least in part, electronic advertisement input.

Next, in 187, process flow 181 sends the electronic advertisement to intended recipient. In one embodiment, process flow 181 sends electronic advertisement to a computing device operated by intended recipient. Process flow 181 may send electronic advertisement directly to intended recipient or may use at least one intermediary or routing system.

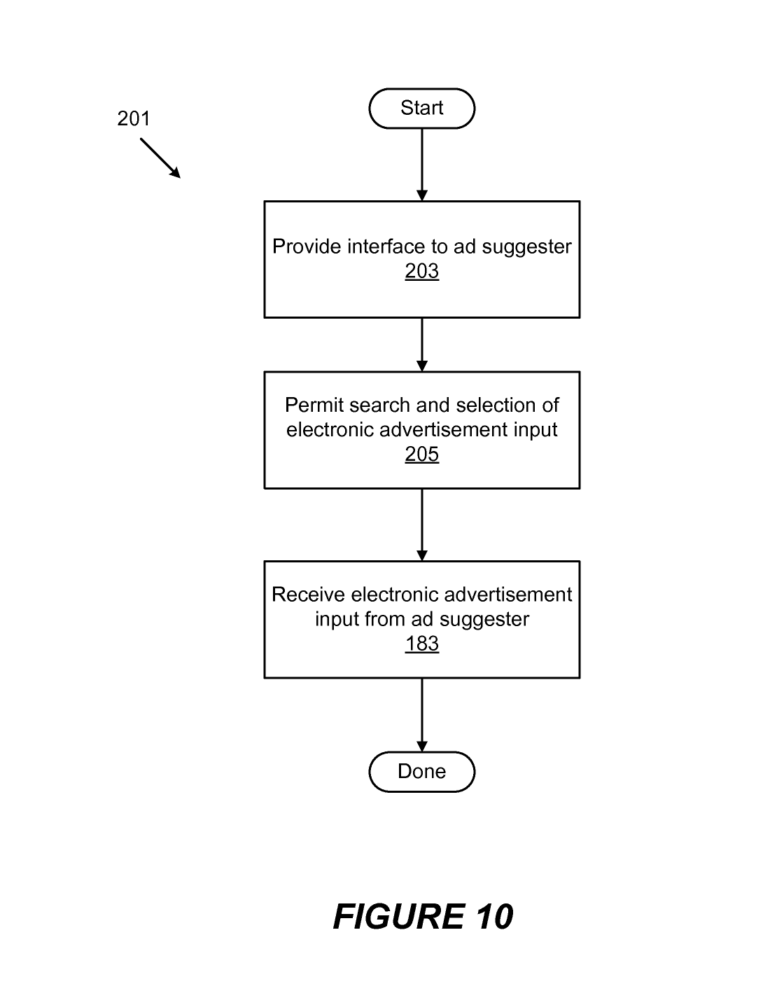

FIG. 10 illustrates a process flow 201 for permitting an ad suggester to provide electronic advertisement input to select or suggest an ad in accordance with another embodiment of the present invention.

Process flow 201 begins by providing an ad suggestion interface to an ad suggester 203. The ad suggestion interface 12 may employ any suitable electronic format for displaying ad information that permits a suggester to select or suggest an ad. Suitable electronic format include a website, a social network page for receiving ad input, a mobile application for receiving ad input suitable for use on mobile devices, an application, a plug-in, an applet, an extension, an add-in, etc.

In a specific embodiment, ad suggestion interface 12 renders a GUI to the suggester. The GUI provides suggester 4 with a) a graphical region or means to load, import, read, search, filter advertisement data, and b) a region to present the ad results based on input received so far. Graphical regions for entering ad input can include known text or graphic input tools such as dialogue boxes, search boxes and resultant lists, static controls, drop-down menus, list boxes, pop-up menus, edit controls, combo boxes, radio buttons, check boxes, push buttons, text selection options, text highlight options, images, pictures, and the like. In addition, utilities to facilitate the presentation of ads may include vertical or horizontal scroll bars for navigation and toolbar buttons to control which ads in a long set are visible.

Next, in 205, process flow 201 permits an ad suggester to use an ad suggestion interface to select or search for ads and provide ad input that corresponds to the consumer information from the intended ad recipient. In one embodiment, the electronic advertisement input includes information for any company, person, product, or service. The ad suggestion interface may permit the suggester to search through a database of advertisers and/or ads. In another embodiment, 205 permits a suggester to search or otherwise locate any electronic advertisement he seeks and the suggestion interface permits the suggester to select any this ad.

Using the ski trip example, process flow 201 permits the ad suggester to search for a specific ski resort and to select the ski resort. Suggester may also use process flow 201 to search for all ski resorts in the Salt Lake City area, and then filter and/or sort by cost of lift ticket and/or the amount of compensation that the suggester will receive when the ad is redeemed.

Process flow 201 may further permit the suggester to search and/or sort within the list of advertisements that fit the input criteria, such as searching for and/or sorting by lift ticket cost and equipment rental. Process flow 201 may also permit a suggester to search for nearby lodging, travel, rental car, among others. In this manner, process flow 201 permits an ad suggester to locate advertisements that fit the specific personal needs of a particular ad recipient at a given time.

Next, process flow 201 receives the electronic advertisement input, as further described in 183 of process flow 181 in FIG. 9.

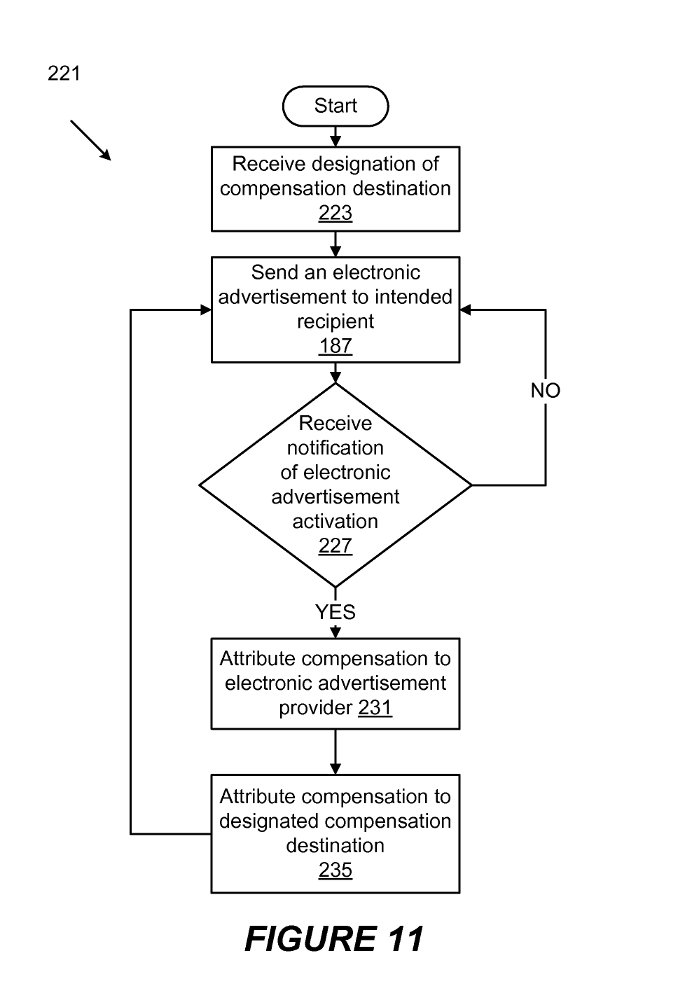

FIG. 11 illustrates a process flow 221 for attributing an incentive or compensation within an interpersonal advertising system in accordance with a specific embodiment.

Process flow 221 begins by receiving a designation of a compensation destination (223) for the compensation resulting from providing input for an interpersonal electronic advertisement. Compensation may be attributed to any bank account or other suitable electronic compensation destination. For example, an ad suggester may provide a personal checking account number to the interpersonal ad service at 223; process flow 221 then subsequently deposits funds in the checking account. Other examples of compensation destinations for receiving compensation include: other bank accounts, a PayPal account, Spare Change account, a social networking pay mechanism or infrastructure, a Facebook credit or cash account (such as Pay with Facebook'), among others. Bank accounts may include personal accounts, business accounts, those for charitable organizations, etc. Digital credits and tokens are also suitable for use as a destination for compensation.

Compensation as contemplated herein is not limited by who receives the funds as a result of any action by an ad suggester or recipient. The financial destination need not belong to the suggester. For example, a grandparent may attribute funds from the grandparent's ad suggestion activities to a bank account for a grandchild. A suggester that supports a charity may designate the charity, or a specific bank account for a charity, as the financial destination for their ad revenues. Multiple people may also specify the same charity, thereby cumulatively generating significant funds for the charity only using ad input actions by its supporters.

Next, in 187, process flow sends an electronic advertisement to a recipient, as further described in 187 of process flow 181.

Process flow 221 then receives a notification that the ad recipient activated an electronic advertisement (227). As the term is used herein, activating an electronic advertisement may include one or more of: completing a transaction that was initiated using an interpersonal electronic advertisement (e.g., the recipient was sent to a website to make the purchase using a link embedded in the ad 16), completing a transaction that otherwise corresponds to electronic advertisement (e.g., the ad brought the ad recipient to a retailer's website, and the recipient purchased a product or service similar to the product or service conveyed in the electronic ad, but not the particular product or service conveyed in the electronic ad), viewing the electronic advertisement, or clicking the electronic advertisement. A recipient that completes a transaction using the interpersonal ad often leads to larger financial rewards for suggester than just viewing the ad. Some ads may receive multiple compensations (e.g., a viewing compensation and a purchase compensation) or just a single compensation (e.g., just a related purchase by the ad recipient.)

In one embodiment, process flow 221 proactively or periodically verifies whether the intended recipient activated an electronic advertisement. If the recipient activated the electronic advertisement, then process flow 221 proceeds to 231. If the intended recipient did not activate an electronic advertisement, the process flow may check again for an activation after some period of time, and may continue to check until the verification returns an affirmative result or until the ad is terminated. Process flow 221 may place or embed a tracking number and/or tracking program for the advertisement, which refers to a unique number or software used to track the status of the ad. Whenever a recipient activates the ad, that activation is tracked online and signaled to the electronic advertisement provider. If a product or service is purchased, then the recipient pays the advertiser, vendor or seller, or an intermediary for either, and the advertiser, vendor or seller compensates the suggester and/or the electronic advertisement provider for that activation. In one embodiment, process flow 221 uses cookies to track ad and purchase status or other recipient activity in response to an ad 16. In a specific embodiment of online use, cookies are used in two stages of online recipient tracking: 1) at ad load by the recipient, and 2) when the ad is clicked and the recipient is delivered to the seller or a website for the seller, such as Amazon, to make a purchase. The cookies permit compensation for a suggester when the recipient activates an advertisement.

Next, in 231, process flow 221 attributes compensation to the electronic advertisement provider, such as an interpersonal electronic advertisement service as further described above in FIG. 2. In one embodiment, the electronic advertisement service and ad suggester share the proceeds of a referral for a successful purchase, as paid by a vendor that made the sale. In a specific embodiment, the ad suggester and electronic ad service provider split the proceeds 50/50. In another specific embodiment, the ad suggester and electronic ad service provider split the proceeds 33/67. Other sharing schemes are contemplated. In another specific embodiment, the electronic ad service provider receives compensation for providing the advertisement to the intended recipient, without any further activity by the recipient. In a specific embodiment where the ad was sent to the recipient via a social network, process flow attributes at least a portion of the compensation to the social network.

Next, in 235, process flow 221 attributes compensation to the financial destination designated for that ad, as designated in 223. Compensation refers to any type of incentive, whether monetary (e.g., a percentage of a purchase deposited in the suggester's bank account), or in another form such as a discount on a present or future consumer transaction, a coupon, merchandise, an award, products, services, electronic tokens, virtual currency, rebate, among others. In one embodiment, process flow 235 maintains a record of the suggester's electronic advertisement input and the electronic advertisement that corresponds to the input which was sent to the intended recipient. In this embodiment, the computing system need not provide the incentive to ad suggester; it only attributes the incentive to the ad suggester and keeps a record of the attributed incentives.

Compensation for a purchase may vary. In one embodiment, process flow 221 attributes compensation to a suggester based on a percentage of a transaction, where the percentage that does not change over time. A compensation percentage that does not change between successive activated ads is referred to herein as a ‘flat rate’ compensation percentage. In the jewelry store example, the son may receive a flat rate compensation percentage for all of his ads, such as 5%, therefore receiving 5% of the transaction price of his father's purchase at jewelry store.

In another embodiment, process flow 221 implements a variable compensation structure. For example, process flow 221 may pay a suggester a higher compensation percentage on their first ad that successfully converts into an ad delivery to a recipient, or their first ad that successfully resulted in a purchase by the recipient, in order to enlist new suggesters. Process flow 221 then pays a second compensation percentage (e.g., a lower flat rate) after the first successful ad.

In another embodiment, process flow 221 uses a conversation rate to help determine the compensation percentage attributed to a suggester. The conversion rate describes a success ratio of ads sent by a suggester. The conversion rate may be determined using a number of techniques and with a variety of inputs. In one embodiment, the conversion rate corresponds to a total number of ad activations relative to a number of total electronic advertisement inputs and/or electronic ads sent in response to the input. For example, one suitable conversion rate uses a ratio of a number of prior ad activations (purchase only) for a suggester related to the number of prior electronic advertisements initiated by the suggester. The conversion rate may be determined using statistics between: a) a suggester and recipient, b) a suggester and all his recipients, c) a suggester and a group of contacts (e.g., ski trip friends, or college friends, etc.), and/or d) combinations thereof. In a specific embodiment, the conversion rate is a global conversion rate for all ads and/or inputs made by a suggester. This variable rate of compensation tied to a conversion rate incentivizes suggesters to provide electronic advertisement input and ads that are highly likely to result in purchases by recipients. It also disincentivizes spamming. Process flow 221 recalculates the conversion rate periodically to reflect a current conversion rate and corresponding compensation percentage.

In the jewelry store example, the conversion rate (for all recipients or just his father) may dictate the son's compensation on his father's purchase. If the son previously sent 40 total ads and 20 were activated, his conversion rate would be 50%. If all 40 of his ad suggestions were activated, the son's conversion rate would be 100%. As the son's conversion rate increases, so does his compensation for a given activation. Likewise, as his conversion rate decreases, so does his compensation. In this manner, son is incentivized to initiate advertisements that are more likely to result in recipient activation.

In another embodiment, process flow 221 uses a tiered conversion rate system to attribute compensation to a suggester. The tiered system includes a number of tiers for the suggester's conversion rate, where each conversion rate tier conveys a dedicated compensation rate. In this embodiment, process flow 221 attributes a compensation percentage of the transaction based on the suggester's conversion rate at the time of sending the ad. Changes (up or down) to the suggester's conversion rate cause the suggester to move between the conversion rate tiers and their predetermined conversion rate thresholds. Typically, a higher conversion rate tier results in a higher compensation percentage using the tiered system. For an increasing conversion rate, once the next conversion rate threshold number is reached, the compensation percentage increases.

For example, if the son's conversion rate is 19%, and he suggests a jewelry store ad to father, and father activates the jewelry ad, this elevates the son's conversion rate above 20%, which represents a higher tier of compensation when the conversion rate tiers are set at 10% increments—10%, 20%, 30%, 40%, etc. Since the son suggested the ad while his conversion rate was 19%, he would receive compensation based on the compensation structure for a 19% conversion rate. On future activated ads, however, the son is eligible for the higher compensation at the compensation rate given to the high tier at 20%, while his conversion rate remains above 20%.

This tiered conversion rate incentive structure may employ any number of tiers, where each successively higher tier conveys an increased compensation percentage, and each tier having a minimum conversion rate to qualify for the increased compensation percentage. Should the conversion rate decrease to below the threshold level for a tier, then the suggester's compensation percentage decreases to correspond with the lower conversion rate tier. A tier may be a range of conversion rates or may represent a single number.

In another specific embodiment, the suggester receives a compensation percentage, as further described above, until a minimum number of ads are sent, so as to provide initial incentive to join the interpersonal advertising service. After the minimum number of ads are sent, the incentive structure changes, e.g. goes to a flat rate or becomes variable according to the tiered system. In this second instance, once the minimum number of ads are sent, the incentive changes in relation to the number of successful activations. In this manner, a suggester receives a first compensation percentage for an initial threshold number of ad suggestions, and receives a variable rate of return, as further described above, once the initial threshold is met. In some embodiments, the dynamic rate of return does not fall below the initial flat rate. For example, a sample incentive scheme offers compensation for the first 20 ad activations at 5% of the corresponding transactions. If the son's first ad input is a jewelry store ad to father, who activates the ad by using it at jewelry store in a consumer transaction, where the total purchase price was $500, then the son receives $25 since it was son's first ad. Son 4 continues to receive this 5% rate for his inputs until he provides 20 (or some other threshold) inputs that result in ad activations and his compensation would then be variable, using variable compensation percentage techniques described above.

Other compensation schemes are contemplated. In another embodiment, the compensation percentage varies in relation to the total amount of the transaction price. For example, the incentive rate for a $100 ski rack might be 5%, and suggester 4 receives $5, while the incentive rate for a $10,000,000 home purchase or yacht might be 1% and ad suggester 10 receives $100,000. In this manner, a business can control how much it rewards suggesters to bring customers to the business. In another compensation scheme, process flow 221 attributes a flat fee for a purchase that is irrespective of the purchase price or conversion rate or any other factor. For example, process flow 221 may pay a suggester $3 for a certain ad that converts into a purchase by the recipient.

After attribution of compensation in 235 process flow 221 may repeat and return to 187 and send a new electronic advertisement to the recipient.

FIG. 12 illustrates a diagram of a sample network 241 in which systems and methods consistent with the principles of the present disclosure may be implemented. Network 241 includes one or more clients 243 connected to one or more servers 245-247 via a network 249. Two clients 243 and two servers 245-247 have been illustrated as connected to network 249 for simplicity. In practice, there may be more or fewer clients and servers. Also, in some instances, a client performs a function of a server and a server performs a function of a client.

Clients 243 are electronic devices, such as a personal computer, a wireless telephone, a personal digital assistant (PDA), a laptop computer, a mobile device, an mp3 player, a tablet, a television, a thin client, or any other type of computation of communication device, a thread or process running on one of these devices, or an object executable by one of these devices. One or more users (e.g., an ad suggester 4 or recipient 8) are associated with each client 243. Servers 245 and 247 include server entities that access, fetch, aggregate, process, search or maintain data in a manner consistent with the principals of the disclosure. Clients 243 and servers 245 and 247 connect to network 249 via at least one network interface that may include one or more wired, wireless, cellular or optical connections, or any other type of connection. The network interface relays communications to network 249. In one embodiment, clients 243 or servers 245 and 247 include a network interface dedicated to receiving input and a second network interface dedicated to send data to the network 249. In a specific embodiment, clients 243 or servers 245 and 247 includes a single network interface that both receives and sends data via the network 249.

In one embodiment, server 245 includes an advertisement system 251 useable by users at clients 243. Server 245 may implement an advertisement platform with advertisements from one or more vendors and sources, index the ads and store information associated with the ad data in a storage. In some embodiments, server 245 hosts advertisements that are provided to users at clients 243. In one embodiment, ad system 251 provides an advertisement suggestion interface to clients 243, where the ad system provides a listing of data that user 4 may select from or search when providing electronic advertisement input 10. In another embodiment, ad system 251 executes an advertisement provision function, at the request of user 4 at client 243, and sends ad 16 to another user 8.

Server 247 stores or maintains data that may be crawled by server 245. Such data may include information described above for data storage 30.

Network 249 includes one or more networks of any type, including a local area network (LAN), a wide area network (WAN), a metropolitan area network (MAN), a telephone network, such as the Public Switched Telephone Network (PSTN) or a Public Land Mobile Network (PLMN), an intranet, the Internet, a memory device, or a combination of networks. The telephone network may further include 3G, 4G, or Mobile WiMAX, Long Term Evolution (LTE). The PLMN(s) may further include a packet-switched sub-network, such as, for example, General Packet Radio Service (GPRS), Cellular Digital Packet Data (CDPD), or Mobile IP sub-network.

While servers 245-247 are shown as separate entities, it may be possible for one of servers 245-247 to perform one or more of the functions of the other one of servers 245-247. For example, servers 245 and 247 may be implemented as a single server. It may also be possible for a single one of servers 245 and 247 to be implemented as two or more separate (and possibly distributed) devices.

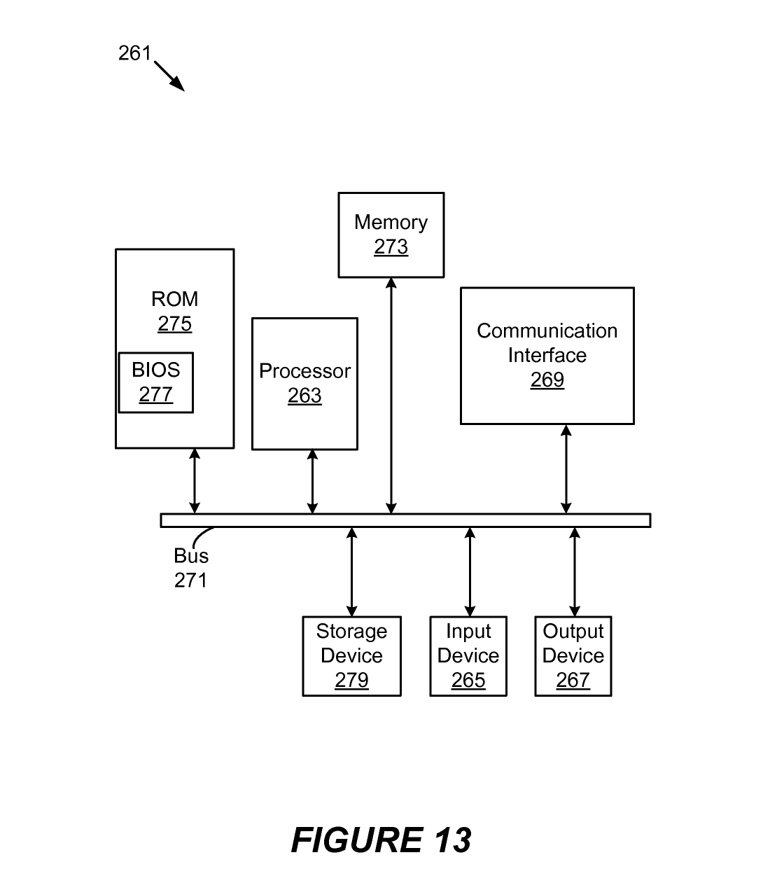

FIG. 13 illustrates a sample computing system 261, which may correspond to one or more of clients 243 and/or servers 245-247. Computer system 261 comprises a processor, or CPU, 263, input device 265, output device 267, communication interface 269, system bus 271, one or more main memory 273, ROM 275, BIOS 277, and storage device 279. System bus 271 permits digital communication between system processor 263 and ROM 275, as well as permits communication between other components within system 261 and processor 263 and/or ROM 275.

Processor 263 is a commercially available microprocessor such as one of the Intel or AMD family of chips, or another suitable commercially available processor. Processor 263 digitally communicates with ROM 275 via system bus 271, which may comprise a data bus, control bus, and address bus for communication between processor 263 and memory 273. CPU 263 is also coupled to the communication interface 269 by system bus 271 to permit data transfers to and from computing system 261.

System memory includes read only memory (ROM) 275. Other memories may be included or substituted for ROM 275, such as random access memory (RAM) 273. Computer system 261 may also include a storage device 279, such as a hard disk drive or an optical disk drive, for example. The drives and their associated computer-readable media provide non-volatile storage for system 261. A number of program modules are stored in the drives, ROM 275, and/or RAM, including an operating system, one or more application programs, other program modules, and program data. Although data storage above refers to a hard disk and optical disk, those skilled in the art will appreciate that other types of storage are suitable for use with a computer system, such as magnetic cassettes, flash memory cards, USB memory sticks, and the like. In addition, not all computer systems, such as PDAs and other portable devices include multiple external memory options.

Communication interface 269 provides an interface between CPU 263 and such peripheral devices as a display device, input device 265, output 267, network interface, and/or any other I/O device. For example, a mouse used as input device 265 digitally communicates with processor 263 through a serial port 269 that is coupled to system bus 271. Other interfaces, such as a game port, a universal serial bus (USB) or fire wire, may also provide digital communication between a peripheral device and processor 263. Output 267 may comprise one or more speakers employed by a headphone or speaker system. Input device 265 allows a user to enter commands and information into the computer system 261, and may comprise a keyboard, a mouse, a position-sensing pad on a laptop computer, a stylus working in cooperation with a position-sensing display on a PDA, a touch screen system, or the like.

In addition to personal computers such as desktop computers and laptop computers, a variety of other computer systems and computer devices employing a digital processor, memory and a display device may implement techniques described herein. Handheld computers and other small portable digital devices such as cell phones and digital cameras are increasingly integrating video display and computer functionality. One current trend is hybrid entertainment devices that integrate the functionality of computer systems, phones, and gaming systems. Any of these devices may implement the advertising methods and systems described herein. The scope of digital computer systems is expanding hurriedly and creating new devices suitable for use herein.

Embodiments of the present invention further relate to computer readable media that include executable program instructions for performing interpersonal advertisement techniques described herein. The media and program instructions may be those specially designed and constructed for the purposes of the present invention, or any kind well known and available to those having skill in the computer software arts. When executed by a processor, these program instructions are suitable to implement any of the methods and techniques, and components thereof, described above. Examples of computer-readable media include, but are not limited to, magnetic media such as hard disks, semiconductor memory, optical media such as CD-ROM disks; magneto-optical media such as optical disks; and hardware devices that are specially configured to store program instructions, such as read-only memory devices (ROM), flash memory devices, EEPROMs, EPROMs, etc. and random access memory (RAM). Examples of program instructions include both machine code, such as produced by a compiler, and files containing higher-level code that may be executed by the computer using an interpreter.

Interpersonal advertising system software and interfaces such as those described herein may be implemented using a number of computer languages and in a number of programming environments. One suitable language is Java, available from Sun Microsystems of Sunnyvale, Calif. Another suitable programming environment is the Microsoft Windows® programming environment, which provides a series of operating systems suitable for implementing the present invention both on laptop computers and handheld computers. C or C++ are also suitable for use herein.

Although the foregoing invention has been described in some detail for purposes of clarity of understanding, those skilled in the art will recognize that various modifications may be made within the scope of the appended claims. In addition, although advertising has not been detailed for every type of electronic device, the present invention is suitable with any technology that provides electronic advertisements. The invention is, therefore, not limited to the specific features and embodiments described herein and claimed in any of its forms or modifications within the scope of the appended claims.

What is claimed is:

1. A method for sending an electronic advertisement in a social network, the method comprising:
receiving electronic advertisement input from an electronic advertisement suggester, the electronic advertisement input relating to consumer information for an intended recipient of the electronic advertisement, the consumer information received by the electronic advertisement suggester from the intended recipient and relating to a potential consumer transaction for the intended recipient;
determining the electronic advertisement at least partially using the electronic advertisement input; and
sending the electronic advertisement to the intended recipient in the social network, wherein the intended recipient is a member of the social network.

2. The method of claim 1 wherein the electronic advertisement input relates to consumer information that is given electronically from the intended recipient to the electronic advertisement suggester via the social network.

3. The method of claim 2 wherein the electronic advertisement input relates to consumer information that is given from the intended recipient directly to the electronic advertisement suggester via the social network.

4. The method of claim 3 wherein the electronic advertisement input relates to consumer information that is given from the intended recipient to the electronic advertisement suggester using a status post or text message in the social network.

5. The method of claim 1 wherein the social network includes a recipient social network environment and a suggester social network environment.

6. The method of claim 5 wherein the intended recipient is a member of all authorized viewers for the electronic advertisement suggester in the suggester social network environment.

7. The method of claim 5 wherein the intended recipient is a member of a subgroup of authorized viewers for the electronic advertisement suggester in the suggester social network environment.

8. The method of claim 5 wherein the social network includes a news feed and sending the electronic advertisement includes sending the electronic advertisement for display in the social network recipient environment awhile the news feed is displayed in the social network environment.

9. The method of claim 5 wherein the social network environment includes at least one status post and sending the electronic advertisement includes sending the electronic advertisement for display in the social network environment while the at least one status post is displayed in the social network environment.

10. The method of claim 5 wherein the recipient social network environment includes a recipient social network page wherein the intended recipient contributes at least a portion of the content displayed on the recipient social network page.

11. The method of claim 1 wherein the intended recipient includes an electronic device with a software interface to the social network.

12. The method of claim 1 wherein receiving the electronic advertisement input occurs using an electronic advertisement graphical user interface configured to receive the electronic advertisement input from the electronic advertisement suggester while the suggester is logged into the social network.

13. The method of claim 1 wherein the electronic advertisement input includes a selection by the electronic advertisement suggester of the electronic advertisement from a set of advertisements.

14. A system for sending advertisements in a social network, comprising:
an advertisement suggestion interface configured to receive electronic advertisement input from an electronic advertisement suggester, the electronic advertisement input relating to consumer information for an intended recipient of the electronic advertisement, the consumer information received by the electronic advertisement suggester from the intended recipient and relating to a potential consumer transaction for the intended recipient;
an advertisement provision module for determining the electronic advertisement at least partially using the electronic advertisement input; and
at least one network interface configured to receive the electronic advertisement input and to send the electronic advertisement to the intended recipient in the social network, wherein the intended recipient is a member of the social network.

15. The system of claim 14 further comprising a compensation module configured to a) store a compensation destination for the electronic advertisement suggester; and b) attribute a compensation to the compensation destination.

16. The system of claim 15 wherein the compensation module is configured to store a conversation rate that compares a) a number of prior electronic advertisements suggested by the electronic advertisement suggester within the social network, and b) a number of prior activations within the number of prior electronic advertisements suggested by the electronic advertisement suggester within the social network.

17. The system of claim 15 wherein the compensation is a monetary compensation.

18. An social network advertisement system comprising:
an electronic advertisement that describes, via a social network, an offer to engage in a transaction between an intended recipient of the electronic advertisement and entity vendor, wherein the electronic advertisement includes at least one of a subject and the vendor;
a URL that, when activated, directs the intended recipient to a) a website operated by a company that provided the advertisement, or b) to a second website that permits the intended recipient to initiate a potential consumer transaction related to the electronic advertisement;
electronic advertising input from an electronic advertisement suggester, the electronic advertisement input relating to consumer information for the intended recipient of the electronic advertisement, the consumer information received by the electronic advertisement suggester from the intended recipient and relating to the potential consumer transaction for the intended recipient.

19. The social network advertisement system of claim 18 further including electronic communication of the consumer information from the intended recipient to the electronic advertisement suggester via the social network.

20. The social network advertisement system of claim 19 wherein the system includes electronic communication of the consumer information directly from the intended recipient to the electronic advertisement suggester via the social network.
